(19) United States
(12) Patent Application Publication
(10) Pub. No.: US 2018/0060818 A1
(43) Pub. Date: Mar. 1, 2018

(54) CONFERENCE ASSISTANCE SYSTEM AND CONFERENCE ASSISTANCE METHOD

(71) Applicants: Yorichika ISHIYAMA, Kanagawa (JP); Hiroyuki KIMBARA, Kanagawa (JP); Yuichi TAKAMIYA, Kanagawa (JP); Takeshi SUZUKI, Kanagawa (JP); Masaaki KAGAWA, Tokyo (JP); Takahiro YAMAMOTO, Kanagawa (JP)

(72) Inventors: Yorichika ISHIYAMA, Kanagawa (JP); Hiroyuki KIMBARA, Kanagawa (JP); Yuichi TAKAMIYA, Kanagawa (JP); Takeshi SUZUKI, Kanagawa (JP); Masaaki KAGAWA, Tokyo (JP); Takahiro YAMAMOTO, Kanagawa (JP)

(73) Assignee: Ricoh Company, Ltd., Tokyo (JP)

(21) Appl. No.: 15/683,809

(22) Filed: Aug. 23, 2017

(30) Foreign Application Priority Data
Aug. 31, 2016 (JP) 2016-169664

(51) Int. Cl. G06Q 10/10; G06Q 10/06; H04L 12/18

(52) U.S. Cl. CPC G06Q 10/103; H04L 12/1831; G06Q 10/101; G06Q 10/0635

(57) ABSTRACT

A system and method of conference assistance, each of which: receives voices or writings input by a plurality of participants participating in a conference relating to a project; calculates, based on the received voices or writings, an evaluation value used for evaluating the project; transmits the calculated evaluation value to the project evaluation server; and controls a display to display a project evaluation information representing an evaluation result of the project, the project evaluation information being received from the project evaluation server in response to transmission of the evaluation value.

### CROSS-REFERENCE TO RELATED APPLICATIONS

This patent application is based on and claims priority pursuant to 35 U.S.C. §119(a) to Japanese Patent Application No. 2016-169664, filed on Aug. 31, 2016, in the Japan Patent Office, the entire disclosure of which is hereby incorporated by reference herein.

### BACKGROUND

### Technical Field

The present invention relates to a conference assistance system and a conference assistance method.

### Description of the Related Art

Various tools such as a configuration management tool, a bug management tool, and a development assistance tool are used in projects such as a development project. By using such tools, for example, an administrator, or a person in charge of such project, tries to prevent the project from failing.

In addition, techniques for quantifying the risk that a proceeding project fails, determining a time-series change in the quantified risk, and detecting a sign of the project failure are known.

### SUMMARY

Example embodiments of the present invention include a system and method of conference assistance, each of which: receives voices or writings input by a plurality of participants participating in a conference relating to a project; calculates, based on the received voices or writings, an evaluation value used for evaluating the project; transmits the calculated evaluation value to the project evaluation server; and controls a display to display a project evaluation information representing an evaluation result of the project, the project evaluation information being received from the project evaluation server in response to transmission of the evaluation value.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an example of a configuration of a conference assistance system according to a first embodiment;

FIG. 2 is a schematic block diagram illustrating an example of a hardware configuration of an electronic whiteboard according to the first embodiment;

FIG. 3 is a schematic block diagram illustrating an example of a hardware configuration of a project management apparatus according to the first embodiment;

FIG. 4 is a schematic diagram illustrating an example of a functional configuration of the conference assistance system according to the first embodiment;

FIGS. 5A and 5B (FIG. 5) are a sequence diagram illustrating an example operation of evaluating a project, performed by the conference assistance system according to the first embodiment;

FIG. 6 is an illustration of an example of a screen displaying project evaluation information;

FIG. 7 is a flowchart illustrating an example of a risk evaluation value calculation process according to the first embodiment;

FIG. 8 is an illustration of an example of a risk evaluation value table according to the first embodiment;

FIG. 9 is a schematic diagram describing an example operation of generating project evaluation information;

FIG. 10 is a schematic diagram illustrating an example of a functional configuration of a conference assistance system according to a second embodiment;

FIG. 11 is an illustration of an example of a risk evaluation value table according to the second embodiment;

FIG. 12 is a flowchart illustrating an example of a risk evaluation value calculation process according to the second embodiment;

FIG. 13 is a schematic diagram illustrating an example of a functional configuration of a conference assistance system according to a third embodiment;

FIG. 14 is an illustration of an example of a set word information table according to the third embodiment;

FIG. 15 is an illustration of an example of a risk evaluation value table according to the third embodiment;

FIG. 16 is a flowchart illustrating an example of a risk evaluation value calculation process according to the third embodiment;

FIG. 17 is a schematic diagram illustrating an example of a functional configuration of a conference assistance system according to a fourth embodiment;

FIGS. 18A and 18B (FIG. 18) are a sequence diagram illustrating an example operation of evaluating a project, performed by the conference assistance system according to the fourth embodiment;

FIG. 19 is a flowchart illustrating an example of a risk evaluation value calculation process according to the fourth embodiment;

FIG. 20 is a schematic diagram illustrating an example of a functional configuration of a conference assistance system according to a fifth embodiment;

FIG. 21 is an illustration of an example of a risk evaluation value table according to the fifth embodiment;

FIGS. 22A and 22B (FIG. 22) are a sequence diagram illustrating an example operation of evaluating a project, performed by the conference assistance system according to the fifth embodiment;

FIG. 23 is a flowchart illustrating an example of a risk evaluation value calculation process according to the fifth embodiment;

FIG. 24 is a schematic diagram illustrating an example of a functional configuration of an conference assistance system according to a sixth embodiment;

FIG. 25 is an illustration of an example of a risk evaluation value table according to the sixth embodiment;

FIGS. 26A and 26B (FIG. 26) are a sequence diagram illustrating an example operation of evaluating a project, performed by the conference assistance system according to the sixth embodiment;

FIG. 27 is a flowchart illustrating an example of a risk evaluation value calculation process according to the sixth embodiment;

FIG. 28 is a schematic diagram illustrating an example of a functional configuration of an conference assistance system according to a seventh embodiment; and

FIGS. 29A and 29B (FIG. 29) are a sequence diagram illustrating an example operation of evaluating a project, performed by the conference assistance system according to the seventh embodiment.

The accompanying drawings are intended to depict embodiments of the present invention and should not be interpreted to limit the scope thereof. The accompanying drawings are not to be considered as drawn to scale unless explicitly noted.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present invention will be described in detail below with reference to the accompanying drawings.

<System Configuration>

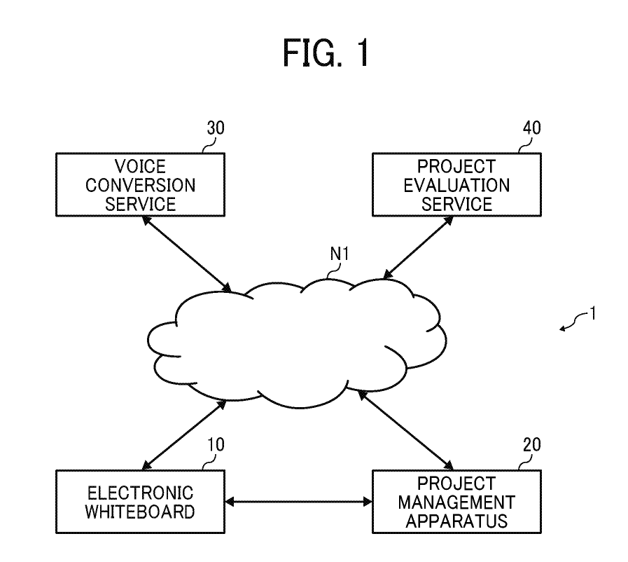

A configuration of a conference assistance system 1 according to a first embodiment will be described first with reference to FIG. 1. FIG. 1 is a schematic diagram illustrating an example of a configuration of the conference assistance system 1 according to the first embodiment.

As illustrated in FIG. 1, the conference assistance system 1 according to the first embodiment includes an electronic whiteboard 10 and a project management apparatus 20. In addition, the conference assistance system 1 according to the first embodiment includes a voice conversion service 30 and a project evaluation service 40, which are connected to the electronic whiteboard 10 and the project management apparatus 20 via a network N1, which is a wide-area network such as the Internet.

The electronic whiteboard 10 may be used during a conference (meeting) that may be related to various projects such as a system development project, for example. The electronic whiteboard 10 is capable of displaying data of electronic files or the like on a display, receiving handwritten characters input using an electronic pen or a user's finger or hand, and collecting (receiving) voices with a microphone. Such an electronic whiteboard 10 is also referred to as an interactive whiteboard (IWB).

The electronic whiteboard 10 also displays project evaluation information provided by the project management apparatus 20 on the display. The project evaluation information is information that is created as a result of a project being evaluated by the project evaluation service 40 (in terms of whether the project is stagnant, for example). That is, the project evaluation information is information representing the evaluation result of the project. The project evaluation information includes, for example, information for warning stagnation of the project.

The project management apparatus 20 is, for example, an information processing apparatus that manages the risk of each project. The project management apparatus 20 calculates a value (risk evaluation value) used for evaluating a project (in terms of whether the project is stagnant, for example) from statements made by participants during a conference (regular conference of the project, for example) held using the electronic whiteboard 10. The project management apparatus 20 then transmits the calculated risk evaluation value to the project evaluation service 40 to acquire the project evaluation information.

In this way, the project management apparatus 20 enables the project evaluation information to be displayed on the display of the electronic whiteboard 10 when the conference is started using the electronic whiteboard 10 (that is, when the conference is held), for example. Thus, the conference assistance system 1 according to the first embodiment is capable of showing the project evaluation information to participants of a conference when the conference is held using the electronic whiteboard 10, for example.

The voice conversion service 30 is an external system or apparatus, which operates as a server, to provide a service of converting data (voice data) representing voices input to the electronic whiteboard 10 into text data by using a voice recognition technique, for example.

The project evaluation service 40 is an external system or apparatus, which operates as a server, to provide a service of evaluating a project (in terms of whether the project is stagnant, for example) by using a technology of artificial intelligence (AI) or intelligent agent (IA), for example. That is, the project evaluation service 40 provides a service of evaluating whether the project is stagnant based on the risk evaluation value received from the project management apparatus 20 and returning the project evaluation information.

Note that the voice conversion service 30 and the project evaluation service 40 are external cloud-type services in the first embodiment. However, the type of the voice conversion service 30 and the project evaluation service 40 is not limited to this type, and the voice conversion service 30 and the project evaluation service 40 may be, for example, services provided by an application service provider (ASP) or may be web services.

In addition, the configuration of the conference assistance system 1 illustrated in FIG. 1 is merely an example, and the conference assistance system 1 may have another configuration. For example, the project management apparatus 20 may be included in the electronic whiteboard 10. In this case, the electronic whiteboard 10 calculates the risk evaluation value. In addition, for example, the voice conversion service 30 may be included in the conference assistance system 1, and the project management apparatus 20 may be an external apparatus that provides a cloud-type project management service.

<Hardware Configuration>

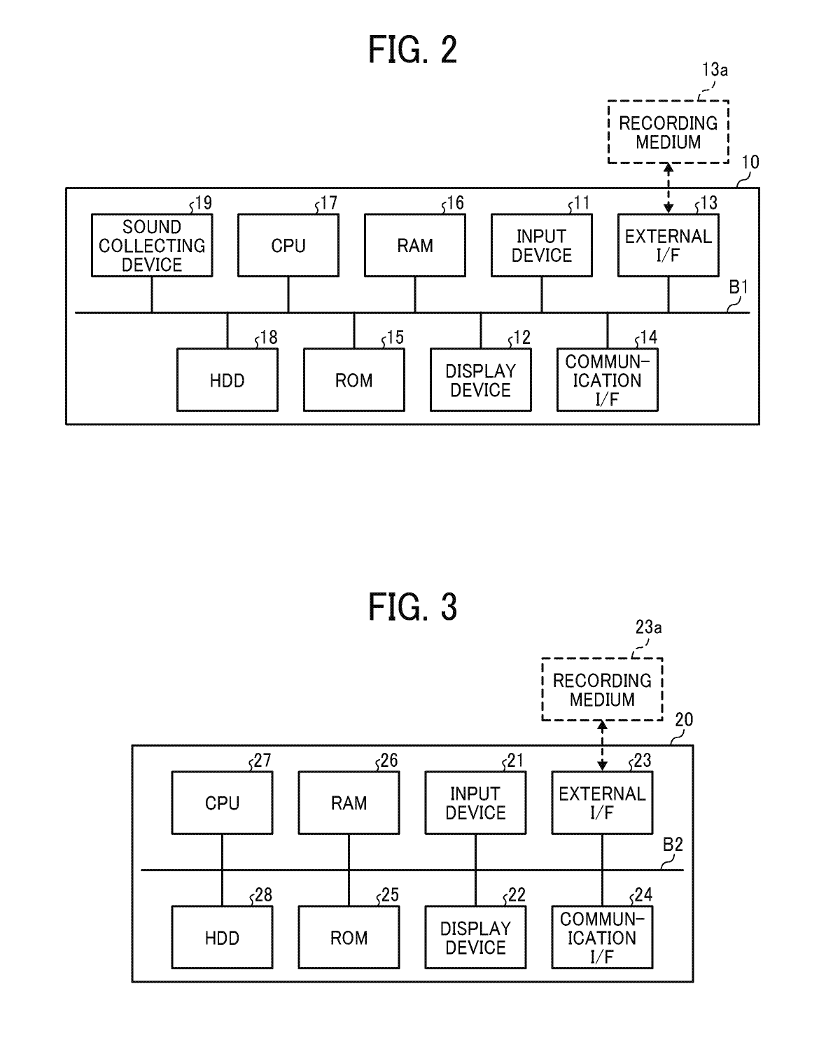

A hardware configuration of the electronic whiteboard 10 according to the first embodiment will be described next with reference to FIG. 2. FIG. 2 is a schematic block diagram illustrating an example of the hardware configuration of the electronic whiteboard 10 according to the first embodiment.

As illustrated in FIG. 2, the electronic whiteboard 10 according to the first embodiment includes an input device 11, a display device 12, an external interface (I/F) 13, a communication I/F 14, and a read-only memory (ROM) 15. The electronic whiteboard 10 according to the first embodiment also includes a random access memory (RAM) 16, a central processing unit (CPU) 17, a hard disk drive (HDD) 18, and a sound collecting device 19. These hardware components are connected to one another via a bus B1.

The input device 11 is, for example, a touch panel and is used by a user to perform various input operations (for example, a handwritten character input operation). The display device 12 is, for example, a display and displays various kinds of information (for example, handwritten characters, various kinds of text, and various icons).

The external I/F 13 is an interface to an external device. Examples of the external device include a recording medium 13a. Thus, the electronic whiteboard 10 is capable of reading data from and writing data to the recording medium 13a or the like via the external I/F 13. Examples of the recording medium 13a include a Universal Serial Bus (USB) flash drive, Compact Disc (CD), Digital Versatile Disc (DVD), and a Secure Digital (SD) memory card.

The communication I/F 14 is an interface for connecting the electronic whiteboard 10 to the network N1 or the like. Thus, the electronic whiteboard 10 is capable of communicating with other apparatuses (for example, the project management apparatus 20 and the voice conversion service 30) via the communication I/F 14.

The HDD 18 is a non-volatile memory device that stores programs and data. Examples of the programs and data stored in the HDD 18 include an operating system (OS) which is system software that controls the electronic whiteboard 10 and application programs that provide various functions on the OS.

The HDD 18 also manages the programs and data stored therein by using a predetermined file system and/or a database (DB). Note that the electronic whiteboard 10 may include, in place of the HDD 18, a drive device (for example, a solid-state drive (SSD)) in which a flash memory is used as a recording medium.

The ROM 15 is a non-volatile semiconductor memory that can keep storing programs and data even when power supply is cut. The ROM 15 stores programs such as a basic input/output system (BIOS) executed at the time of booting of the electronic whiteboard 10 and data such as OS configurations and network configurations. The RAM 16 is a volatile semiconductor memory that temporarily holds programs and data.

The CPU 17 is an arithmetical device that reads programs and data from a memory device, such as the ROM 15 and the HDD 18, to the RAM 16 and executes a process, thereby implementing controls and functions of the electronic whiteboard 10.

The sound collecting device 19 is, for example, a microphone and collects sounds in the vicinity of the electronic whiteboard 10.

With the hardware configuration illustrated in FIG. 2, the electronic whiteboard 10 according to the first embodiment is capable of implementing various processes (described later).

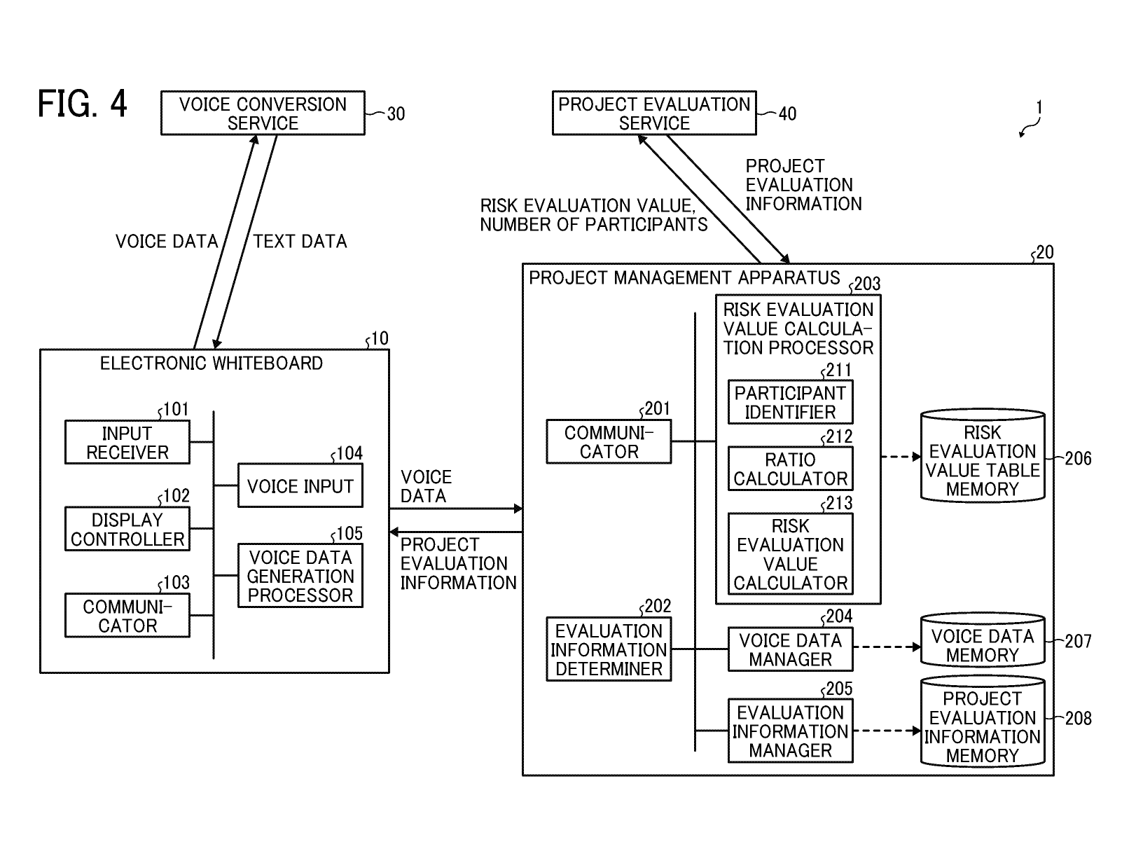

A hardware configuration of the project management apparatus 20 according to the first embodiment will be described next with reference to FIG. 3. FIG. 3 is a schematic block diagram illustrating an example of the hardware configuration of the project management apparatus 20 according to the first embodiment.

As illustrated in FIG. 3, the project management apparatus 20 according to the first embodiment includes an input device 21, a display device 22, an external I/F 23, and a communication I/F 24. The project management apparatus 20 according to the first embodiment also includes a ROM 25, a RAM 26, a CPU 27, and an HDD 28. These hardware components are connected to one another via a bus B2.

The input device 21 is, for example, a keyboard and mouse or a touch panel and is used by a user to perform various input operations. The display device 22 is, for example, a display and displays various kinds of information. Note that the project management apparatus 20 may be configured such that at least one of the input device 21 and the display device 22 is connected to the bus B2 for use as needed.

The external I/F 23 is an interface to an external device. Examples of the external device include a recording medium 23a. Thus, the project management apparatus 20 is capable of reading data from and writing data to the recording medium 23a via the external I/F 23. Examples of the recording medium 23a include a USB flash drive, a CD, a DVD, and an SD memory card.

The communication I/F 24 is an interface for connecting the project management apparatus 20 to the network N1 or the like. Thus, the project management apparatus 20 is capable of communicating with other apparatuses (for example, the electronic whiteboard 10 and the project evaluation service 40) via the communication I/F 24.

The HDD 28 is a non-volatile memory device that stores programs and data. Examples of the programs and data stored in the HDD 28 include an operating system (OS) which is system software that controls the project management apparatus 20 and application programs that provide various functions on the OS.

The HDD 28 also manages the programs and data stored therein by using a file system and/or a DB. Note that the project management apparatus 20 may include, in place of the HDD 28, a drive device (for example, an SSD) in which a flash memory is used as a recording medium.

The ROM 25 is a non-volatile semiconductor memory capable of holding programs and data even when power supply is cut. The ROM 25 stores programs such as BIOS executed at the time of booting of the project management apparatus 20 and data such as OS configurations and network configurations. The RAM 26 is a volatile semiconductor memory that temporarily holds programs and data.

The CPU 27 is an arithmetical device that reads programs and data from a memory device, such as the ROM 25 and the HDD 28, to the RAM 26 and executes a process, thereby implementing controls and functions of the project management apparatus 20.

With the hardware configuration illustrated in FIG. 3, the project management apparatus 20 according to the first embodiment is capable of implementing various processes (described later).

<Functional Configuration>

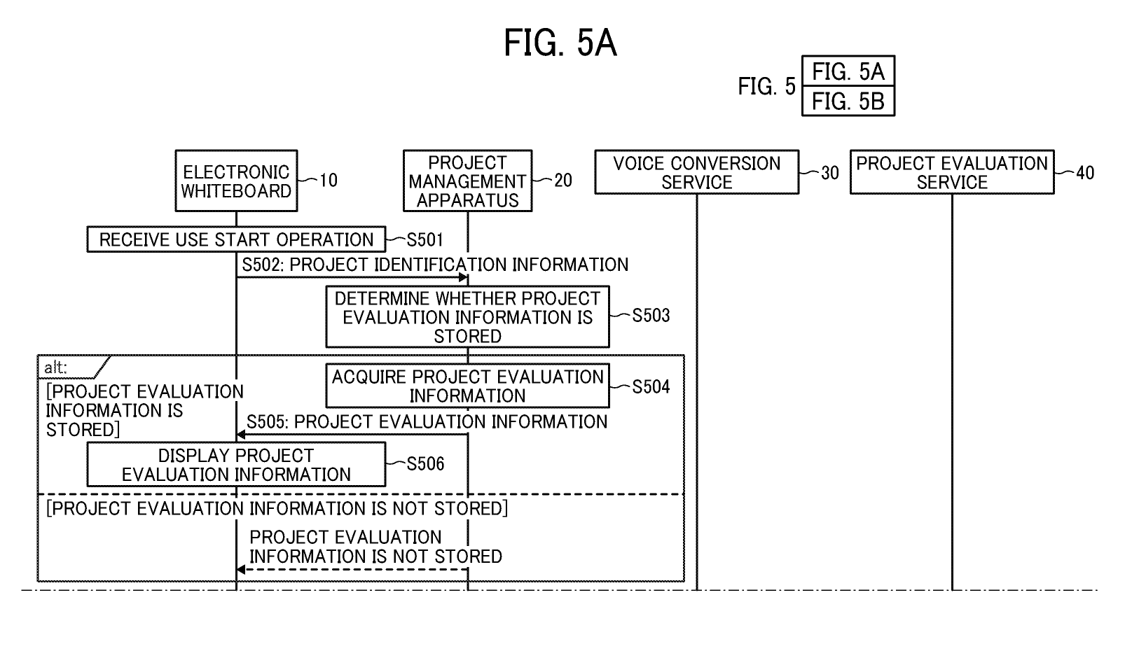

A functional configuration of the conference assistance system 1 according to the first embodiment will be described next with reference to FIG. 4. FIG. 4 is a schematic diagram illustrating an example of the functional configuration of the conference assistance system 1 according to the first embodiment.

As illustrated in FIG. 4, the electronic whiteboard 10 according to the first embodiment includes an input receiver 101, a display controller 102, a communicator 103, a voice input 104, and a voice data generation processor 105. These functional units are implemented by processes which one or more programs installed on the electronic whiteboard 10 cause the CPU 17 to execute.

The input receiver 101 receives various input operations performed by the user. Specifically, the input receiver 101 receives an operation for starting using the electronic whiteboard 10 (use start operation). The input receiver 101 also receives a handwritten character input operation and various selection operations, for example.

The display controller 102 displays various kinds of information. Specifically, the display controller 102 displays project evaluation information. The display controller 102 also displays text represented by text data obtained by the voice conversion service 30 through conversion. The display controller 102 further displays various screens, handwritten characters, etc.

The communicator 103 communicates various kinds of data with other apparatuses (for example, the project management apparatus 20 and the voice conversion service 30). Specifically, the communicator 103 transmits voice data generated by the voice data generation processor 105 to the voice conversion service 30, for example. Thus, the electronic whiteboard 10 is capable of converting voice data into text data by using the voice conversion service 30 and of displaying text represented by the text data through the display controller 102.

The communicator 103 also transmits the voice data generated by the voice data generation processor 105 to the project management apparatus 20, for example. Thus, the project management apparatus 20 is capable of calculating a risk evaluation value from the voice data transmitted by the electronic whiteboard 10 as described later.

The communicator 103 further transmits, in response to the input receiver 101 receiving a use start operation for example, to the project management apparatus 20, information (project identification information) for identifying a project for which a conference is started using the electronic whiteboard 10. For example, an identifier (ID) unique to the project or the name of the project may be used as the project identification information.

The voice input 104 receives input voices. Specifically, the voice input 104 receives sounds (voices) collected by the sound collecting device 19.

The voice data generation processor 105 generates data (voice data) representing voices received by the voice input 104. The voice data generation processor 105 also transmits the generated voice data to the project management apparatus 20 and the voice conversion service 30 via the communicator 103.

As illustrated in FIG. 4, the project management apparatus 20 according to the first embodiment includes a communicator 201, an evaluation information determiner 202, a risk evaluation value calculation processor 203, a voice data manager 204, and an evaluation information manager 205. These functional units are implemented by processes which one or more programs installed on the project management apparatus 20 cause the CPU 27 to execute.

The project management apparatus 20 according to the first embodiment also includes a risk evaluation value table memory 206, a voice data memory 207, and a project evaluation information memory 208. These memories are implemented using the HDD 28, for example. Note that at least one of these memories may be implemented using a memory device or the like connected to the project management apparatus 20 via a network.

The communicator 201 communicates various kinds of data with other apparatuses (for example, the electronic whiteboard 10 and the project evaluation service 40). Specifically, the communicator 201 transmits a risk evaluation value calculated by the risk evaluation value calculation processor 203 to the project evaluation service 40, for example. The communicator 201 also receives project identification information from the electronic whiteboard 10, for example.

In response to receiving project identification information via the communicator 201, the evaluation information determiner 202 determines whether project evaluation information of a project identified by the project identification information is stored in the project evaluation information memory 208.

The risk evaluation value calculation processor 203 performs a process for calculating a risk evaluation value. The risk evaluation value calculation processor 203 includes a participant identifier 211, a ratio calculator 212, and a risk evaluation value calculator 213.

The participant identifier 211 identifies each participant who participates in a conference using the electronic whiteboard 10, based on voice data acquired by the voice data manager 204 from the voice data memory 207.

The participant identifier 211 may identify each participant by using a known speaker recognition technique, for example. In addition, for example, in the case where voices are collected using different microphones for different participants of the conference, the participant identifier 211 may identify the participants from information for identifying respective microphones.

The ratio calculator 212 calculates, for each participant identified by the participant identifier 211, a total statement period during the conference. The ratio calculator 212 then calculates a ratio of a longest total statement period to the entire period of the conference (conference period) (that is, (longest total statement period)/(conference period)100).

With reference to a risk evaluation value table 1000 stored in the risk evaluation value table memory 206, the risk evaluation value calculator 213 calculates a risk evaluation value from the ratio calculated by the ratio calculator 212.

The risk evaluation value table 1000 stored in the risk evaluation value table memory 206 is a table in which the ratio calculated by the ratio calculator 212 and the risk evaluation value are stored in association with each other.

The voice data manager 204 manages voice data stored in the voice data memory 207. Specifically, the voice data manager 204 causes voice data received via the communicator 201 to be stored in the voice data memory 207. The voice data manager 204 also acquires voice data stored in the voice data memory 207.

The evaluation information manager 205 manages project evaluation information stored in the project evaluation information memory 208. Specifically, the evaluation information manager 205 causes project evaluation information received via the communicator 201 to be stored in the project evaluation information memory 208. The evaluation information manager 205 also acquires project evaluation information stored in the project evaluation information memory 208.

The risk evaluation value table memory 206 stores the risk evaluation value table 1000. As described above, the risk evaluation value table 1000 is a table in which the ratio calculated by the ratio calculator 212 and the risk evaluation value are stored in association with each other. Details of the risk evaluation value table 1000 will be described later.

The voice data memory 207 stores voice data. Specifically, the voice data memory 207 stores voice data in association with project identification information, for example.

The project evaluation information memory 208 stores project evaluation information. Specifically, the project evaluation information memory 208 stores project evaluation information in association with project identification information, for example.

<Details of Process>

Details of a process performed by the conference assistance system 1 according to the first embodiment will be described next.

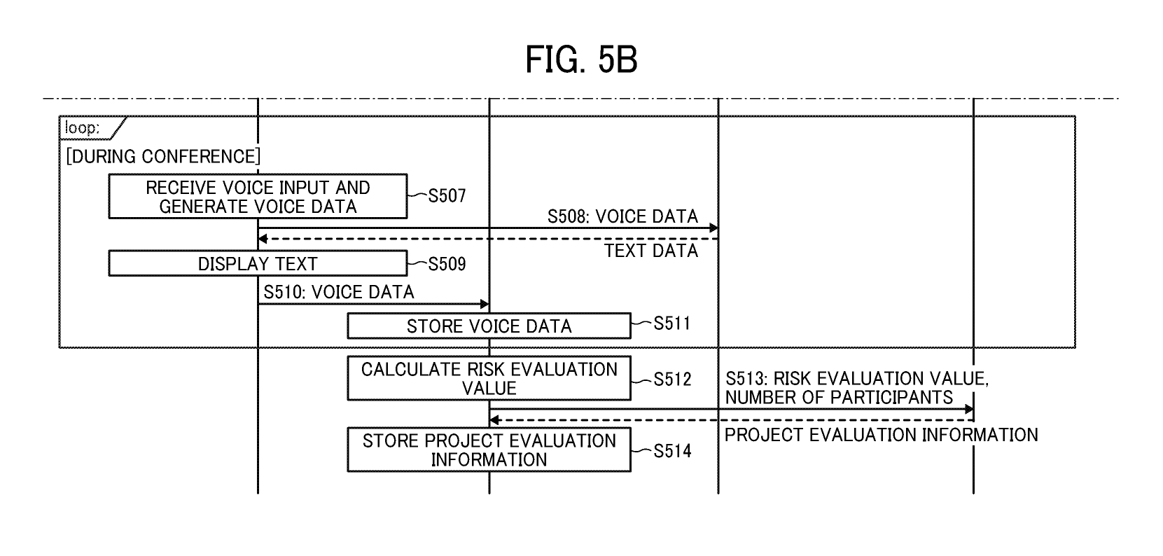

The overview of the process performed by the conference assistance system 1 according to the first embodiment will be described below with reference to FIG. 5. FIG. 5 is a sequence diagram illustrating an example operation of evaluating a project, performed by the conference assistance system 1 according to the first embodiment.

First, the input receiver 101 of the electronic whiteboard 10 receives a use start operation for starting using the electronic whiteboard 10 (step S501).

For example, the user can input information such as a user ID and a password on a predetermined screen displayed by the display controller 102 to perform the use start operation. Alternatively, the user may bring an integrated circuit (IC) card into proximity to a predetermined position of the electronic whiteboard 10, such as where a card reader is provided, to perform the use start operation.

Then, the communicator 103 of the electronic whiteboard 10 transmits, to the project management apparatus 20, project identification information of a project for which a conference is held using the electronic whiteboard 10 (step S502).

Note that the project identification information is input by the user on the predetermined screen displayed by the display controller 102 when the use start operation is performed, for example. Alternatively, the project identification information may be stored in the IC card that is used when the use start operation is performed or may be stored in the electronic whiteboard 10 in association with a user ID stored in the IC card, for example. Alternatively, the project identification information may be associated with an ID (such as a device ID) for identifying the electronic whiteboard 10, for example.

In response to receiving the project identification information via the communicator 201, the evaluation information determiner 202 of the project management apparatus 20 determines whether project evaluation information associated with the project identification information is stored in the project evaluation information memory 208 (step S503).

If it is determined in step S503 that the project evaluation information is stored, the evaluation information manager 205 of the project management apparatus 20 acquires the project evaluation information from the project evaluation information memory 208 (step S504).

Then, the communicator 201 of the project management apparatus 20 transmits, to the electronic whiteboard 10, the project evaluation information acquired by the evaluation information manager 205 (step S505).

The display controller 102 of the electronic whiteboard 10 displays the project evaluation information received via the communicator 103 (step S506).

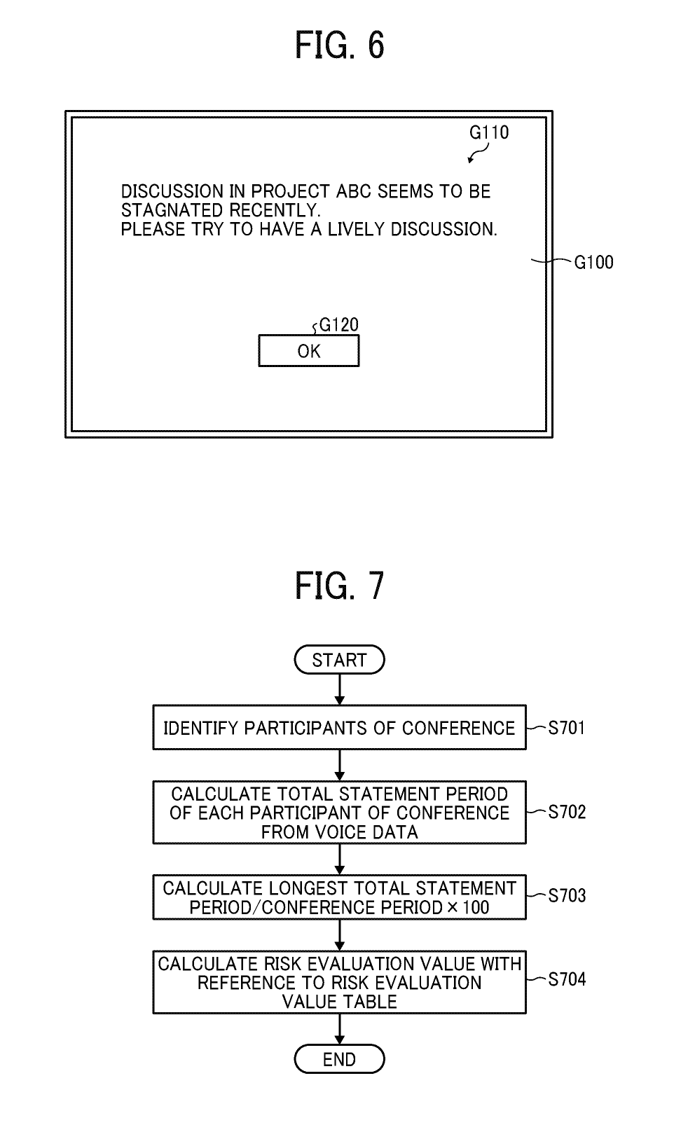

A screen G100 displaying the project evaluation information will be described with reference to FIG. 6. FIG. 6 is an illustration of an example of the screen G100 displaying the project evaluation information.

As illustrated in FIG. 6, the screen G100 includes project evaluation information G110 and an OK button G120. The project evaluation information G110 is a warning message indicating that the project might be stagnant. The OK button G120 is a button for closing the screen G100.

In this way, when a conference of the project is held, the conference assistance system 1 according to the first embodiment displays, on the electronic whiteboard 10, content of the project evaluation information obtained by the project evaluation service 40 through evaluation. Thus, the participants of the conference are presumably encouraged to actively participate in a discussion and to make statements in order to prevent the project from being delayed or cancelled (terminated) due to stagnation of the project, for example.

If it is determined in step S503 that the project evaluation information is not stored, the communicator 201 of the project management apparatus 20 returns, to the electronic whiteboard 10, information indicating that the project evaluation information is not stored.

After the OK button G120 is pressed or after the information indicating that the project evaluation information is not stored is returned, the conference assistance system 1 according to the first embodiment performs processing of steps S507 to S511 (described later) while the conference is continued using the electronic whiteboard 10.

Specifically, the voice input 104 of the electronic whiteboard 10 receives voices (content of statements made by participants of the conference during the conference) collected by the sound collecting device 19. The voice data generation processor 105 of the electronic whiteboard 10 then generates data (voice data) representing the voices received by the voice input 104 (step S507).

Then, the voice data generation processor 105 of the electronic whiteboard 10 transmits the voice data to the voice conversion service 30 via the communicator 103 (step S508). Then, the voice conversion service 30 converts the voice data into text data and returns the text data to the electronic whiteboard 10.

Then, the display controller 102 of the electronic whiteboard 10 displays text represented by the text data returned by the voice conversion service 30 (step S509). In this way, for example, content of statements made by the participants of the conference is displayed as text on the display device 12 of the electronic whiteboard 10. For example, in the case where a plurality of pieces of text data and the reliability degrees of these pieces of text data (indices indicating the reliability of conversion) are returned by the voice conversion service 30, the display controller 102 may display text represented by a piece of text data assigned the highest reliability degree.

Then, the voice data generation processor 105 of the electronic whiteboard 10 transmits the voice data to the project management apparatus 20 via the communicator 103 (step S510). At that time, the voice data generation processor 105 may transmit the project identification information together with the voice data.

In response to receiving the voice data via the communicator 201, the voice data manager 204 of the project management apparatus 20 causes the voice data to be stored in the voice data memory 207 (step S511). At that time, the voice data manager 204 causes the voice data to be stored in the voice data memory 207 in association with the project identification information received in step S503.

In this way, voice data representing vocal statements made by the participants of the conference held using the electronic whiteboard 10 is stored in the voice data memory 207.

After the conference using the electronic whiteboard 10 is finished, the conference assistance system 1 according to the first embodiment performs processing of steps S512 to S514 (described later). In response to receiving a use end operation performed by the user, the input receiver 101 of the electronic whiteboard 10 may transmit information indicating the end of the conference to the project management apparatus 20 via the communicator 103. In addition, the project management apparatus 20 may determine that the conference is finished if the project management apparatus 20 receives no voice data from the electronic whiteboard 10 over a predetermined period, for example.

The risk evaluation value calculation processor 203 of the project management apparatus 20 calculates a risk evaluation value (step S512).

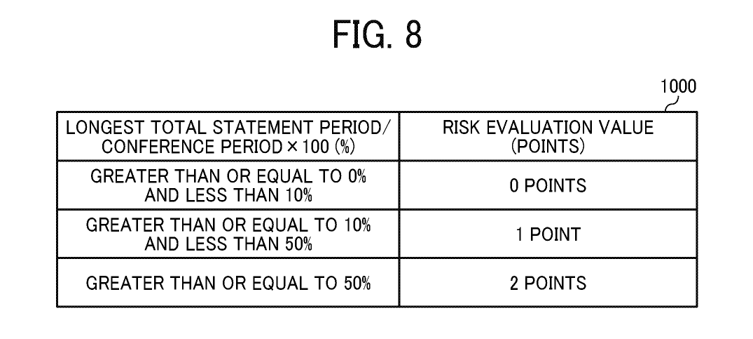

A process of calculating the risk evaluation value (risk evaluation value calculation process) performed in step S512 will be described with reference to FIG. 7. FIG. 7 is a flowchart illustrating an example of the risk evaluation value calculation process according to the first embodiment.

First, the participant identifier 211 acquires, via the voice data manager 204, voice data stored in the voice data memory 207 in association with the project identification information received in step S503 illustrated in FIG. 5. Then, the participant identifier 211 identifies each participant who participates in the conference on the basis of the acquired voice data (step S701). At that time, the participant identifier 211 is able to count the number of participants who participate in the conference.

The number of participants may be input by the user of the electronic whiteboard 10 in step S501 illustrated in FIG. 5, for example, or the number of people who have placed their IC cards in step S501 illustrated in FIG. 5 may be regarded as the number of participants. Alternatively, for example, the electronic whiteboard 10 may detect, using a known person detection technique, people who are in the room where the conference is held and may use the number of detected people as the number of participants of the conference.

Then, the ratio calculator 212 calculates, for each of the participants identified in step S701, a total statement period during the conference (step S702). Specifically, the ratio calculator 212 calculates, for each of the participants identified by the participant identifier 211, the sum of statement periods of the participant from the voice data acquired in step S701.

Then, the ratio calculator 212 calculates a ratio of the longest total statement period to the entire period of the conference (conference period) (i.e., (longest total statement period)/(conference period)100) (step S703). This calculation is performed based on assumption that, if the total statement period of a particular participant such as a facilitator of the conference occupies a large part of the entire period of the conference, the project tends to be stagnant and result in a failure. Note that the conference period is an example of a period of the conference used in the claims.

Then, with reference to the risk evaluation value table 1000 stored in the risk evaluation value table memory 206, the risk evaluation value calculator 213 calculates the risk evaluation value from the ratio calculated by the ratio calculator 212 (step S704).

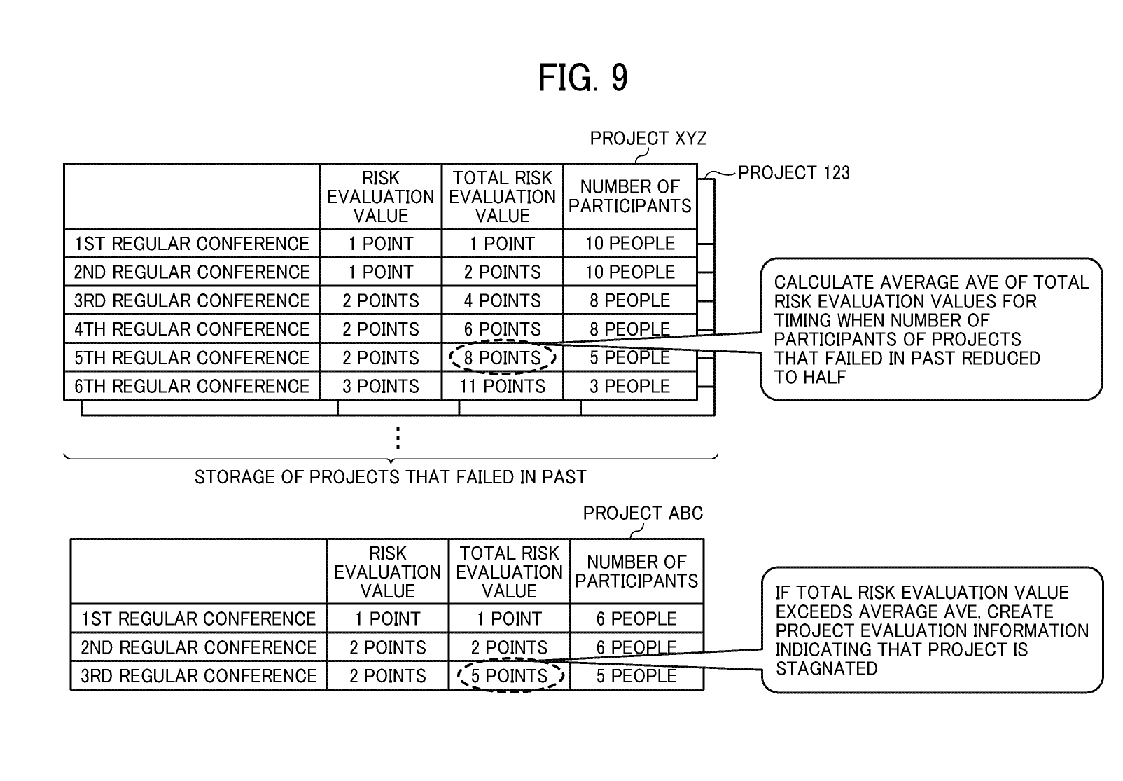

The risk evaluation value table 1000 stored in the risk evaluation value table memory 206 will be described with reference to FIG. 8. FIG. 8 is an illustration of an example of the risk evaluation value table 1000 according to the first embodiment.

As illustrated in FIG. 8, the ratio of the longest total statement period to the conference period is associated with the risk evaluation value in the risk evaluation value table 1000. For example, the ratio of the longest total statement period to the conference period that is “greater than or equal to 0% and less than 10%” is associated with a risk evaluation value of “0 points”. Likewise, for example, the ratio of the longest total statement period to the conference period that is “greater than or equal to 10% and less than 50%” is associated with a risk evaluation value of “point”. In addition, for example, the ratio of the longest total statement period to the conference period that is “greater than or equal to 50%” is associated with a risk evaluation value of “2 points”.

As described above, in the risk evaluation value table 100, the risk evaluation value is associated with the ratio of the longest total statement period to the conference period in accordance with the ratio.

Thus, in step S704, with reference to the risk evaluation value table 1000, the risk evaluation value calculator 213 calculates the risk evaluation value associated with the ratio calculated by the ratio calculator 212.

Referring back to FIG. 5, after step S512, the risk evaluation value calculation processor 203 of the project management apparatus 20 transmits, to the project evaluation service 40 via the communicator 201, the risk evaluation value calculated in step S704 and the number of participants calculated in step S701 (step S513). Then, the project evaluation service 40 evaluates whether the project is stagnant based on the received risk evaluation value, creates project evaluation information, and returns the project evaluation information to the project management apparatus 20.

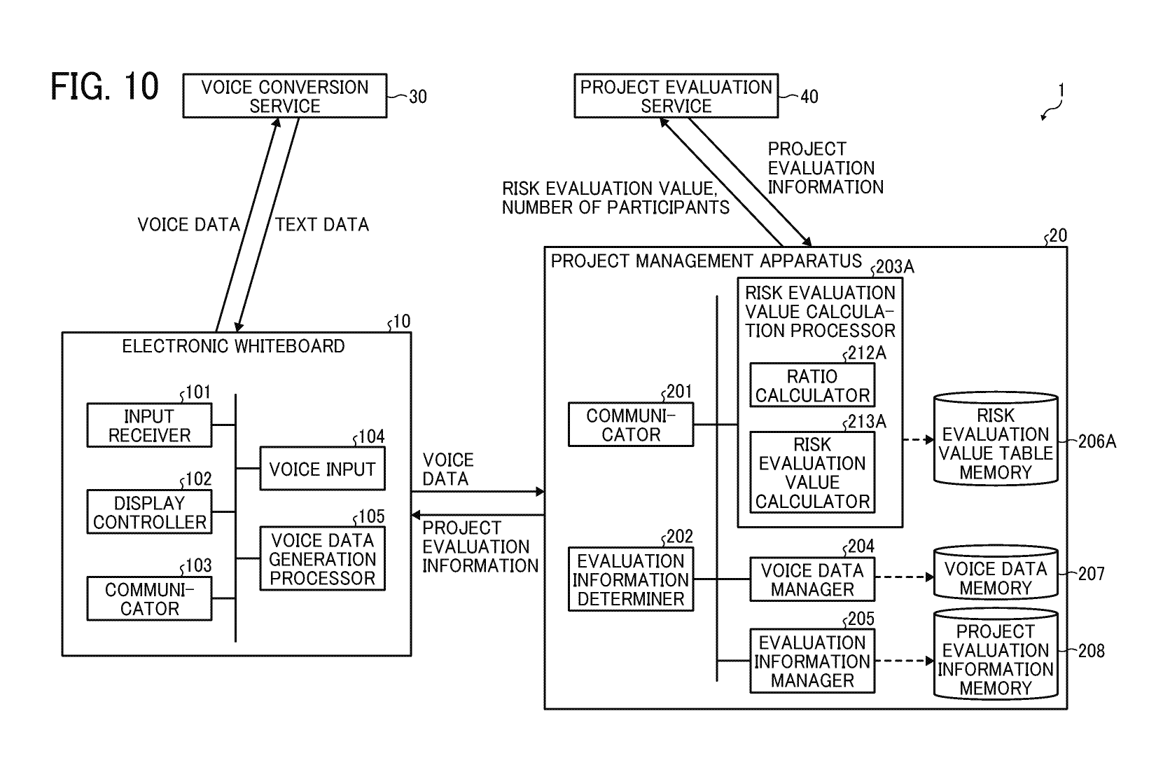

Now, how the project evaluation information is created by the project evaluation service 40 will be described with reference to FIG. 9. FIG. 9 is a schematic diagram describing an example of how the project evaluation information is created.

As illustrated in FIG. 9, the project evaluation service 40 stores risk evaluation values for respective conferences of past failing projects, sums of the risk evaluation values (total risk evaluation values) of the conferences of the past failing projects, and the number of participants of the respective conferences of the past failing projects. Note that the past failing projects are projects that were cancelled halfway and projects that ended naturally, for example.

For example, in the example illustrated in FIG. 9, the risk evaluation value, the total risk evaluation value, and the number of participants of a “project XYZ” are stored for the “1st regular conference” to the “6th regular conference”. Likewise, in the example illustrated in FIG. 9, the risk evaluation value, the total risk evaluation value, and the number of participants are stored for each conference of the failing projects, such as a “project 123”.

In this case, the project evaluation service 40 acquires the total risk evaluation values for a timing at which the number of participants of the conference reduces to a half for all the past failing projects and calculates an average AVE of the acquired total risk evaluation values.

For example, suppose that the electronic whiteboard 10 that has received the use start operation in step S501 illustrated in FIG. 5 is used in a conference of a “project ABC”. In addition, suppose that the risk evaluation value and the number of participants that are transmitted by the project management apparatus 20 in step S513 are “2” and “5”, respectively. In this case, the project evaluation service 40 determines whether the total risk evaluation value of the “project ABC” exceeds the average AVE.

If the project evaluation service 40 determines that the total risk evaluation value of the “project ABC” exceeds the average AVE, the project evaluation service 40 creates project evaluation information indicating that the project is stagnant, for example.

As described above, the project evaluation service 40 evaluates, for example, whether the project is stagnant from stored information regarding the past failing projects and creates the project evaluation information. Note that the risk evaluation value and the number of participants transmitted by the project management apparatus 20 in step S513 are stored by the project evaluation service 40.

Note that the method used by the project evaluation service 40 to create the project evaluation information is not limited to the method described in FIG. 9. For example, the project evaluation service 40 may evaluate whether the project is stagnant based on the stored information regarding the past projects by using a technology of AI or IA and create the project evaluation information. In addition, the criterion used by the project evaluation service 40 for evaluation is not limited to whether the project is stagnant. For example, the project evaluation service 40 may evaluate whether the project is on schedule or whether the quality of the outcome of the project is maintained.

Referring to back to FIG. 5, after step S512, the evaluation information manager 205 of the project management apparatus 20 causes the project evaluation information returned by the project evaluation service 40 to be stored in the project evaluation information memory 208 (step S514). At that time, the evaluation information manager 205 causes the project evaluation information to be stored in the project evaluation information memory 208 in association with the project identification information received in step S503.

In this way, the project evaluation information is stored in the project evaluation information memory 208, and the electronic whiteboard 10 is able to display the project evaluation information when the conference of the project is held as described in steps S502 to S506 above. Thus, the participants of the conference can recognize that the project is stagnant and can have lively discussions in order to prevent the project from being cancelled.

As described above, the conference assistance system 1 according to the first embodiment can evaluate a project (in terms of whether the project is stagnated or delayed or whether the quality of the outcome is decreased) based on the total statement period of a participant who spoke for the longest period.

Thus, the conference assistance system 1 according to the first embodiment can evaluate a project without requiring participants of the conference held using the electronic whiteboard 10 to perform various input operation for evaluating the project or without causing the participants to be conscious about the various inputs for evaluating the project, for example. That is, the conference assistance system 1 according to the first embodiment can evaluate a project if participants of the conference merely make statements during the conference.

The project evaluation information is stored in the project management apparatus 20 according to the first embodiment in step S514. However, the configuration is not limited to this one. For example, the project evaluation information may be transmitted to a terminal device used by a project manager or a director. With this configuration, the project evaluation information can be provided to a director who does not necessarily participate in every conference.

In the conference assistance system 1 according to the first embodiment, the project management apparatus 20 includes the risk evaluation value calculation processor 203. However, the project evaluation service 40 may have functions implemented by the risk evaluation value calculation processor 203. In this case, the electronic whiteboard 10 may transmit voice data directly to the project evaluation service 40.

A second embodiment will be described next. In the second embodiment, a project is evaluated based on a silent period (period for which no participants make any statement) during a conference.

<Functional Configuration>

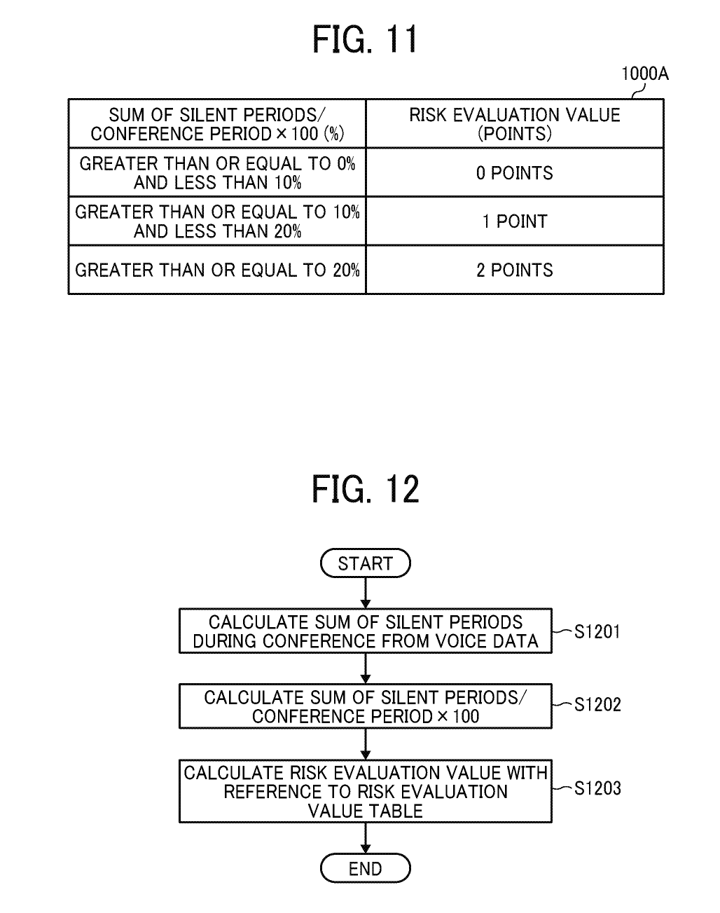

First, a functional configuration of the conference assistance system 1 according to the second embodiment will be described with reference to FIG. 10. FIG. 10 is a schematic diagram illustrating an example of the functional configuration of the conference assistance system 1 according to the second embodiment. Note that a description of functional units that are substantially the same as those of the first embodiment is omitted.

As illustrated in FIG. 10, the project management apparatus 20 according to the second embodiment includes a risk evaluation value calculation processor 203A. The project management apparatus 20 according to the second embodiment also includes a risk evaluation value table memory 206A.

The risk evaluation value calculation processor 203A includes a ratio calculator 212A and a risk evaluation value calculator 213A. The ratio calculator 212A calculates the sum of silent periods (periods for which no participants make any statement) during a conference. The ratio calculator 212A then calculates a ratio of the sum of silent periods to the entire period of the conference (conference period) (i.e., (sum of silent periods)/(conference period)100).

With reference to a risk evaluation value table 1000A stored in the risk evaluation value table memory 206A, the risk evaluation value calculator 213A calculates a risk evaluation value from the ratio calculated by the ratio calculator 212A. The risk evaluation value table 1000A stored in the risk evaluation value table memory 206A is a table in which the ratio calculated by the ratio calculator 212A and the risk evaluation value are stored in association with each other as described later.

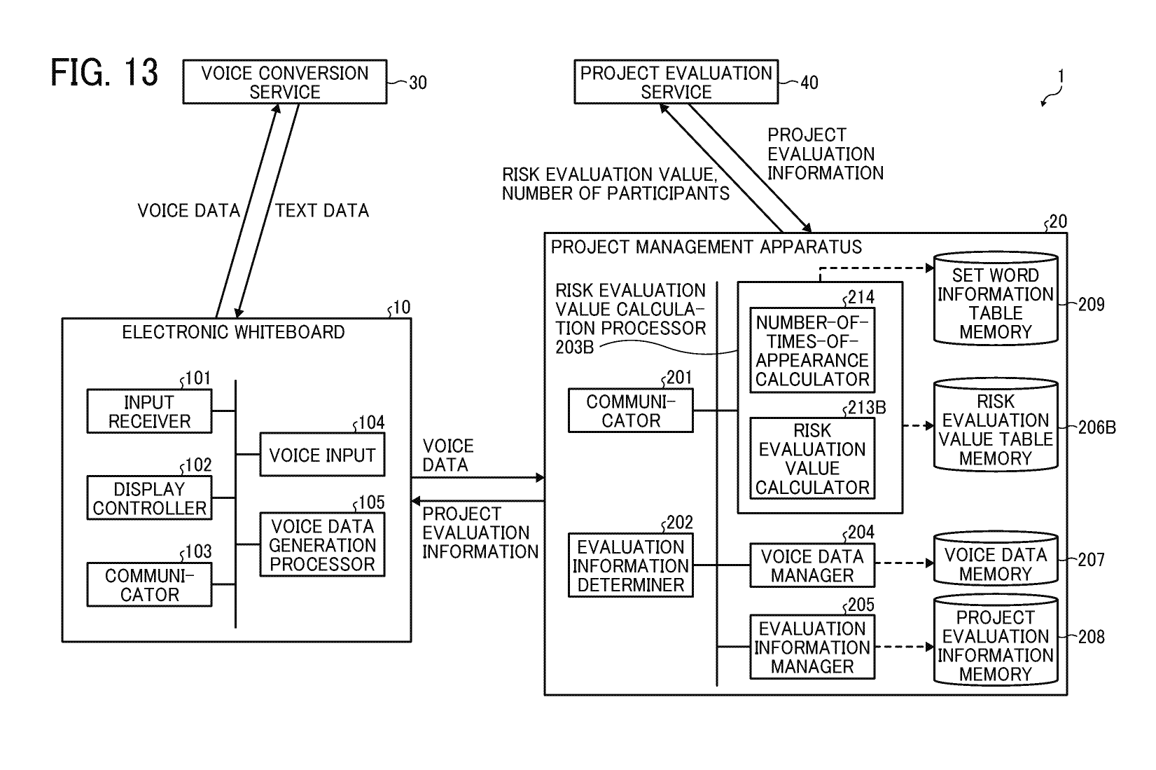

The risk evaluation value table memory 206A stores the risk evaluation value table 1000A. The risk evaluation value table 1000A stored in the risk evaluation value table memory 206A will be described with reference to FIG. 11. FIG. 11 is an illustration of an example of the risk evaluation value table 1000A according to the second embodiment.

As illustrated in FIG. 11, the ratio of the sum of silent periods to the conference period is associated with the risk evaluation value in the risk evaluation value table 1000A. For example, the ratio of the sum of silent periods to the conference period that is “greater than or equal to 0% and less than 10%” is associated with a risk evaluation value of “0 points”. Likewise, for example, the ratio of the sum of silent periods to the conference period that is “greater than or equal to 10% and less than 20%” is associated with a risk evaluation value of “1 point”. In addition, for example, the ratio of the sum of silent periods to the conference period that is “greater than or equal to 20%” is associated with a risk evaluation value of “2 points”.

As described above, in the risk evaluation value table 1000A, the risk evaluation value is associated with the ratio of the sum of silent periods to the conference period in accordance with the ratio.

<Details of Process>

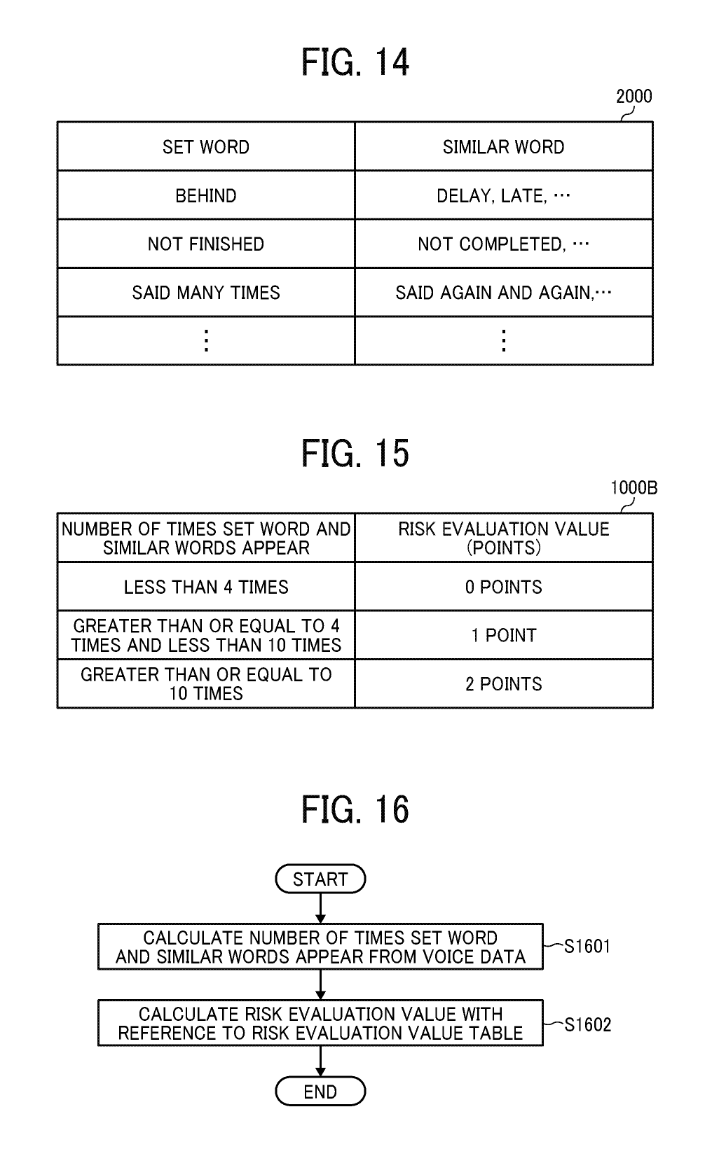

Details of a process performed by the conference assistance system 1 according to the second embodiment will be described next. The second embodiment differs from the first embodiment in the risk evaluation value calculation process. Thus, the risk evaluation value calculation process according to the second embodiment will be described below with reference to FIG. 12. FIG. 12 is a flowchart illustrating an example of the risk evaluation value calculation process according to the second embodiment.

First, the ratio calculator 212A acquires, via the voice data manager 204, voice data stored in the voice data memory 207 in association with the project identification information received in step S503 illustrated in FIG. 5. Then, the ratio calculator 212A calculates the sum of silent periods (periods for which no participants make any statement) during the conference based on the acquired voice data (step S1201).

Then, the ratio calculator 212A calculates a ratio of the sum of silent periods to the entire period of the conference (conference period) (i.e., (sum of silent periods)/(conference period)100) (step S1202). This calculation is performed based on assumption that, if a conference with a long silent period, that is, a conference with a period for which no participants make any statement, is held, the project tends to be stagnant and result in a failure.

Then, with reference to the risk evaluation value table 1000A stored in the risk evaluation value table memory 206A, the risk evaluation value calculator 213A calculates a risk evaluation value from the ratio calculated by the ratio calculator 212A (step S1203). Specifically, with reference to the risk evaluation value table 1000A, the risk evaluation value calculator 213A calculates the risk evaluation value associated with the ratio calculated by the ratio calculator 212A.

As described above, the conference assistance system 1 according to the second embodiment can evaluate a project based on the sum of silent periods during a conference.

A third embodiment will be described next. In the third embodiment, a project is evaluated based on the number of times a predetermined word set in advance (set word or set term) and words synonymous with the set word (similar words or similar terms) appear in voice data.

<Functional Configuration>

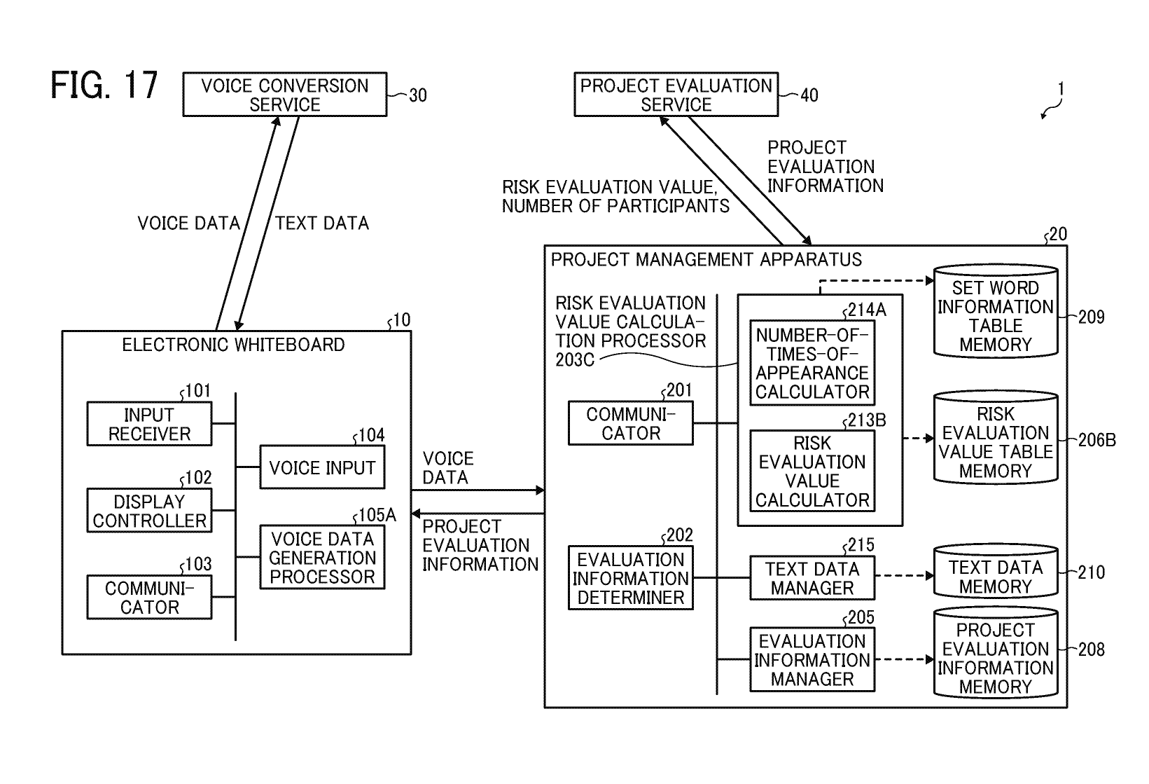

First, a functional configuration of the conference assistance system 1 according to the third embodiment will be described with reference to FIG. 13. FIG. 13 is a schematic diagram illustrating an example of the functional configuration of the conference assistance system 1 according to the third embodiment. Note that a description of functional units that are substantially the same as those of the first embodiment is omitted.

As illustrated in FIG. 13, the project management apparatus 20 according to the third embodiment includes a risk evaluation value calculation processor 203B. The project management apparatus 20 according to the third embodiment also includes a set word information table memory 209 and a risk evaluation value table memory 206B. The set word information table memory 209 can be implemented using the HDD 28, for example. Alternatively, the set word information table memory 209 may be implemented using a memory device connected to the project management apparatus 20 via a network.

The risk evaluation value calculation processor 203B includes a number-of-times-of-appearance calculator 214 and a risk evaluation value calculator 213B.

With reference to a set word information table 2000 stored in the set word information table memory 209, the number-of-times-of-appearance calculator 214 calculates the number of times the set word and the similar words appear in voice data (the number of times of appearance).

With reference to a risk evaluation value table 1000B stored in the risk evaluation value table memory 206B, the risk evaluation value calculator 213B calculates a risk evaluation value from the number of times of appearance calculated by the number-of-times-of-appearance calculator 214. The risk evaluation value table 1000B stored in the risk evaluation value table memory 206B is a table in which the number of times of appearance calculated by the number-of-times-of-appearance calculator 214 and the risk evaluation value are stored in association with each other, as described later.

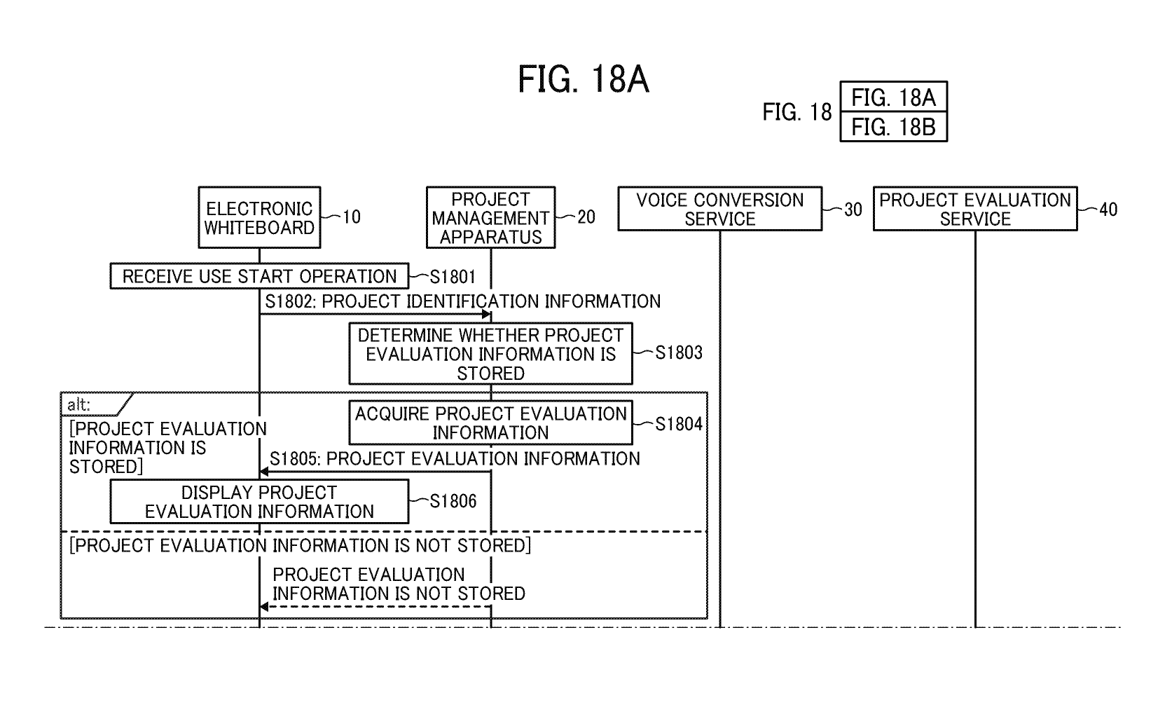

The set word information table memory 209 stores the set word information table 2000. The set word information table 2000 stored in the set word information table memory 209 will be described with reference to FIG. 14. FIG. 14 is an illustration of an example of the set word information table 2000 according to the third embodiment.

As illustrated in FIG. 14, in the set word information table 2000, the set word and the similar words are associated with each other. For example, a set word “behind” is associated with similar words “delay”, “late”, and so on. Likewise, a set word “not finished” is associated with similar words “not completed” and so on.

In this way, in the set word information table 2000, set words that might be mentioned in the conference when the project is stagnant or behind the schedule and similar words synonymous with these set words are associated with each other. Note that words synonymous with a set word are calculated as the similar words by using dictionary data or the like, for example.

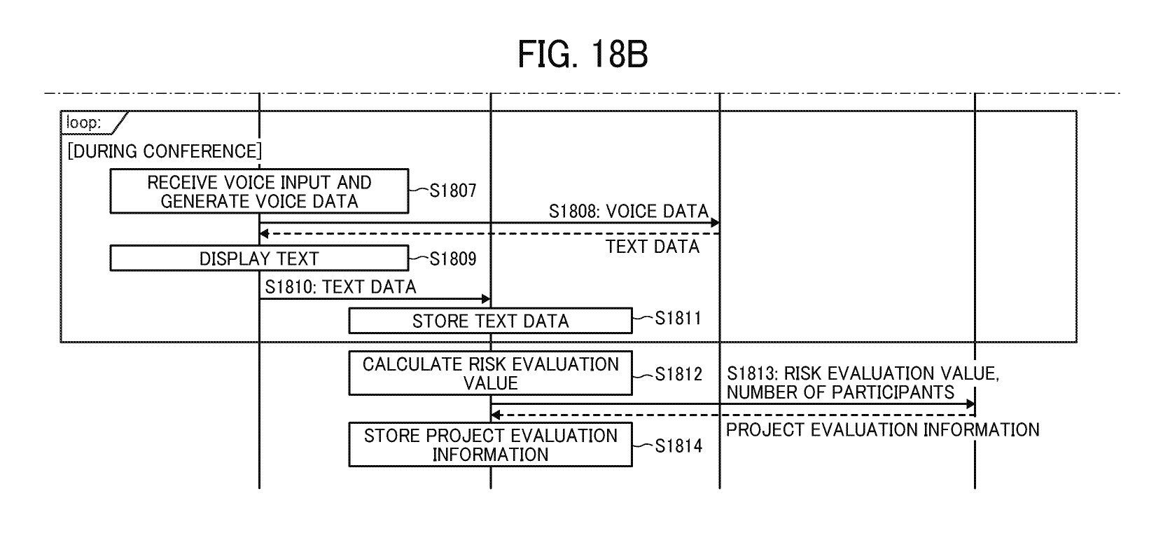

The risk evaluation value table memory 206B stores the risk evaluation value table 1000B. The risk evaluation value table 1000B stored in the risk evaluation value table memory 206B will be described with reference to FIG. 15. FIG. 15 is an illustration of an example of the risk evaluation value table 1000B according to the third embodiment.

As illustrated in FIG. 15, in the risk evaluation value table 1000B, the number of times the set word and the similar words appear in voice data is associated with the risk evaluation value. For example, the number of times of appearance of the set word and the similar words that is “less than three times” is associated with a risk evaluation value of “0 points”. Likewise, for example, the number of times of appearance of the set word and the similar words that is “greater than or equal to 3 times and less than 10 times” is associated with a risk evaluation value of “1 point”. In addition, for example, the number of times of appearance of the set word and the similar words that is “greater than or equal to 10 times” is associated with a risk evaluation value of “2 points”.

As described above, in the risk evaluation value table 1000B, the risk evaluation value is associated with the number of times the set word and the similar words appear in voice data in accordance with the number of times of appearance.

<Details of Process>

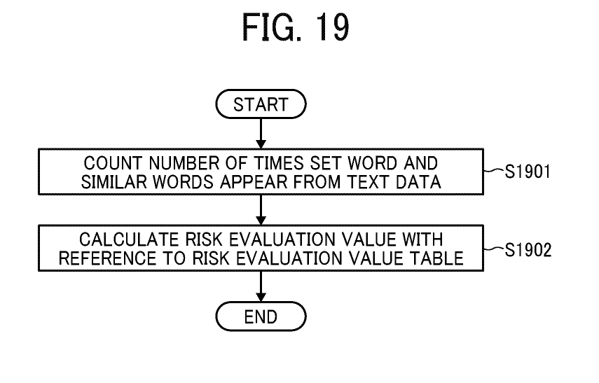

Details of a process performed by the conference assistance system 1 according to the third embodiment will be described next. The third embodiment differs from the first embodiment in the risk evaluation value calculation process. Thus, the risk evaluation value calculation process according to the third embodiment will be described below with reference to FIG. 16. FIG. 16 is a flowchart illustrating an example of the risk evaluation value calculation process according to the third embodiment.

First, the number-of-times-of-appearance calculator 214 acquires, via the voice data manager 204, voice data stored in the voice data memory 207 in association with the project identification information received in step S503 illustrated in FIG. 5. Then, with reference to the set word information table 2000 stored in the set word information table memory 209, the number-of-times-of-appearance calculator 214 calculates the number of times the set words and the similar words appear in the acquired voice data (step S1601).

Then, with reference to the risk evaluation value table 1000B stored in the risk evaluation value table memory 206B, the risk evaluation value calculator 213B calculates a risk evaluation value from the number of times of appearance calculated by the number-of-times-of-appearance calculator 214 (step S1602). This calculation is performed based on assumption that, in the case where set words that might be mentioned during the conference if the project is stagnant or behind the schedule and similar words that are synonymous with the set words are mentioned in the conference often, the project tends to be stagnant and result in a failure.

As described above, the conference assistance system 1 according to the third embodiment can evaluate a project based on the number of times a predetermined word and words synonymous with the predetermined word appear in statements made by participants of the conference.

A fourth embodiment will be described next. In the fourth embodiment, a project is evaluated based on the number of times a predetermined word or similar words appear in text data into which voice data is converted by the voice conversion service 30.

<Functional Configuration>

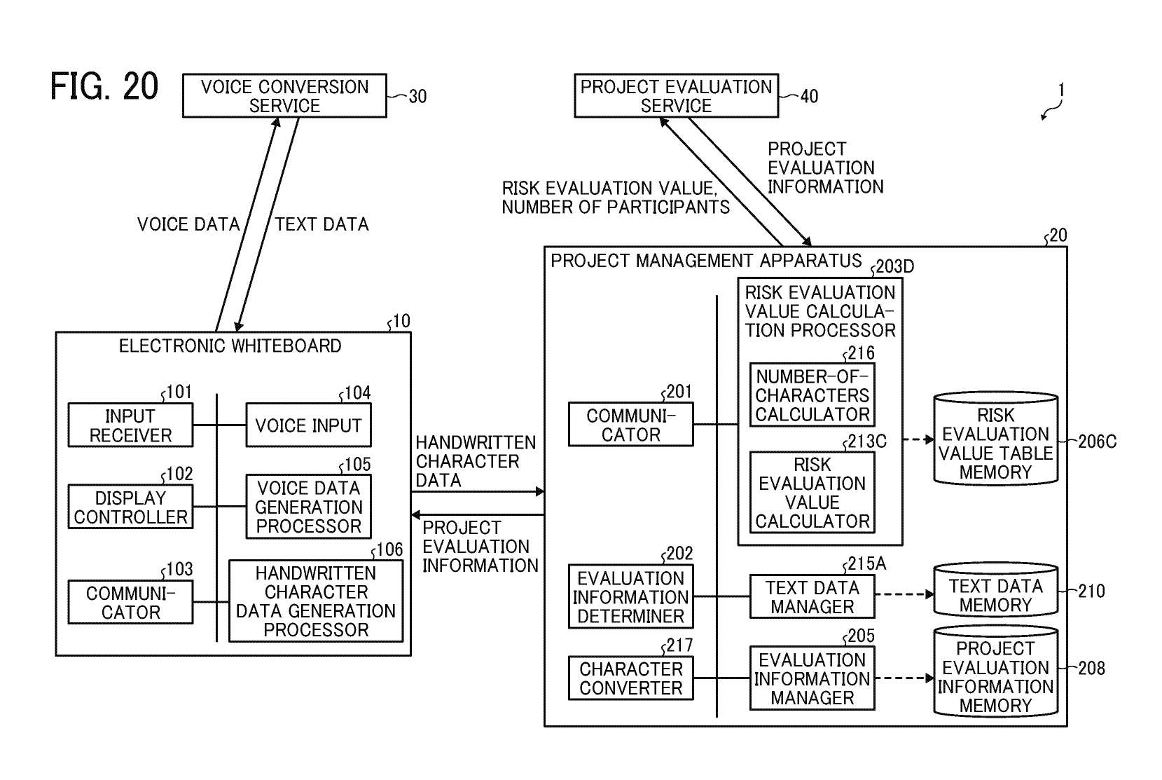

First, a functional configuration of the conference assistance system 1 according to the fourth embodiment will be described with reference to FIG. 17. FIG. 17 is a schematic diagram illustrating an example of the functional configuration of the conference assistance system 1 according to the fourth embodiment. Note that a description of functional units that are substantially the same as those of the third embodiment is omitted.

As illustrated in FIG. 17, the electronic whiteboard 10 according to the fourth embodiment includes a voice data generation processor 105A. In response to receiving, via the communicator 103, text data obtained by the voice conversion service 30 through conversion, the voice data generation processor 105A transmits the text data to the project management apparatus 20 via the communicator 103.

As illustrated in FIG. 17, the project management apparatus 20 according to the fourth embodiment includes a risk evaluation value calculation processor 203C and a text data manager 215. The text data manager 215 is implemented by a process which one or more programs installed on the project management apparatus 20 cause the CPU 27 to execute.

The project management apparatus 20 according to the fourth embodiment also includes a text data memory 210. The text data memory 210 can be implemented using the HDD 28, for example. Alternatively, the text data memory 210 may be implemented using a memory device connected to the project management apparatus 20 via a network.

The risk evaluation value calculation processor 203C includes a number-of-times-of-appearance calculator (counter) 214A. With reference to the set word information table 2000 stored in the set word information table memory 209, the number-of-times-of-appearance calculator 214A counts the number of times a set word and similar words appear in text data (the number of times of appearance).

The text data manager 215 manages text data stored in the text data memory 210. Specifically, the text data manager 215 causes text data received via the communicator 201 to be stored in the text data memory 210. The text data manager 215 also acquires text data stored in the text data memory 210.

The text data memory 210 stores text data. Specifically, the text data memory 210 stores text data in association with project identification information, for example.

<Details of Process>

Details of a process performed by the conference assistance system 1 according to the fourth embodiment will be described next.

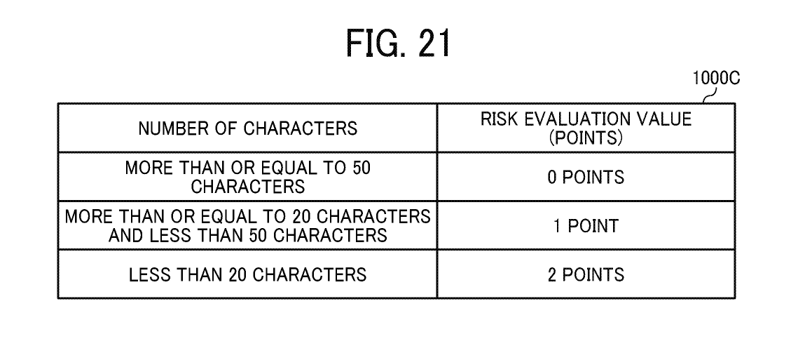

The overview of the process performed by the conference assistance system 1 according to the fourth embodiment will be described below with reference to FIG. 18. FIG. 18 is a sequence diagram illustrating an example operation of evaluating a project, performed by the conference assistance system 1 according to the fourth embodiment. Since processing of steps S1801 to S1809 is substantially the same as the processing of steps S501 to S509 illustrated in FIG. 5, a description thereof is omitted.

After step S1809, the voice data generation processor 105A of the electronic whiteboard 10 transmits, to the project management apparatus 20 via the communicator 103, text data returned by the voice conversion service 30 (step S1810). At that time, the voice data generation processor 105A may transmit project identification information together with the text data.

In response to receiving the text data via the communicator 201, the text data manager 215 of the project management apparatus 20 causes the text data to be stored in the text data memory 210 (step S1811). At that time, the text data manager 215 causes the text data to be stored in the text data memory 210 in association with the project identification information received in step S1803.

In this way, text data that represents text of vocal statements made by participants of the conference held using the electronic whiteboard 10 is stored in the text data memory 210.

After the conference using the electronic whiteboard 10 is finished, the conference assistance system 1 according to the fourth embodiment performs processing of steps S1812 to S1814. Since processing of steps S1813 and S1814 is substantially the same as the processing of steps S513 and S514 illustrated in FIG. 5, a description thereof is omitted. As in FIG. 5, in response to receiving a use end operation performed by the user, the input receiver 101 of the electronic whiteboard 10 may transmit information indicating the end of the conference to the project management apparatus 20 via the communicator 103. In addition, the project management apparatus 20 may determine that the conference is finished if the project management apparatus 20 receives no text data from the electronic whiteboard 10 over a predetermined period, for example.

The risk evaluation value calculation processor 203C of the project management apparatus 20 calculates a risk evaluation value (step S1812).

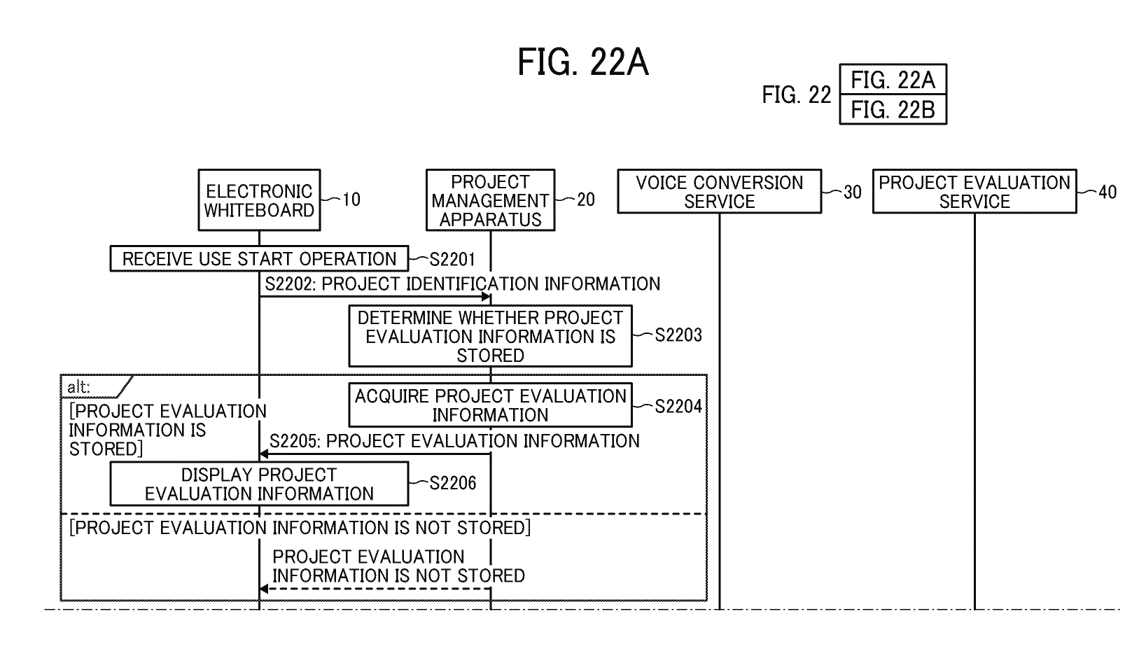

A process of calculating the risk evaluation value (risk evaluation value calculation process) performed in step S1812 will be described with reference to FIG. 19. FIG. 19 is a flowchart illustrating an example of the risk evaluation value calculation process according to the fourth embodiment.

First, the number-of-times-of-appearance calculator 214A acquires, via the text data manager 215, text data stored in the text data memory 210 in association with the project identification information received in step S1803 illustrated in FIG. 18. Then, with reference to the set word information table 2000 stored in the set word information table memory 209, the number-of-times-of-appearance calculator 214A counts the number of times the set word and the similar words that appear in the acquired text data (step S1901).

Then, the risk evaluation value calculator 213B calculates a risk evaluation value from the number of times of appearance counted by the number-of-times-of-appearance calculator 214A, with reference to the risk evaluation value table 1000B stored in the risk evaluation value table memory 206B (step S1902). This calculation is performed based on assumption that, in the case where set words that might be mentioned during the conference if the project is stagnant or behind the schedule and similar words that are synonymous with the set words are mentioned during the conference often, the project tends to be stagnant and result in a failure.

As described above, the conference assistance system 1 according to the fourth embodiment can evaluate a project based on the number of times a predetermined word and words synonymous with the predetermined word appear in statements made by participants of the conference, as in the third embodiment.

A fifth embodiment will be described next. In the fifth embodiment, a project is evaluated based on the number of handwritten characters that are input to the electronic whiteboard 10 by using an electronic pen or the user's finger, for example.

<Functional Configuration>

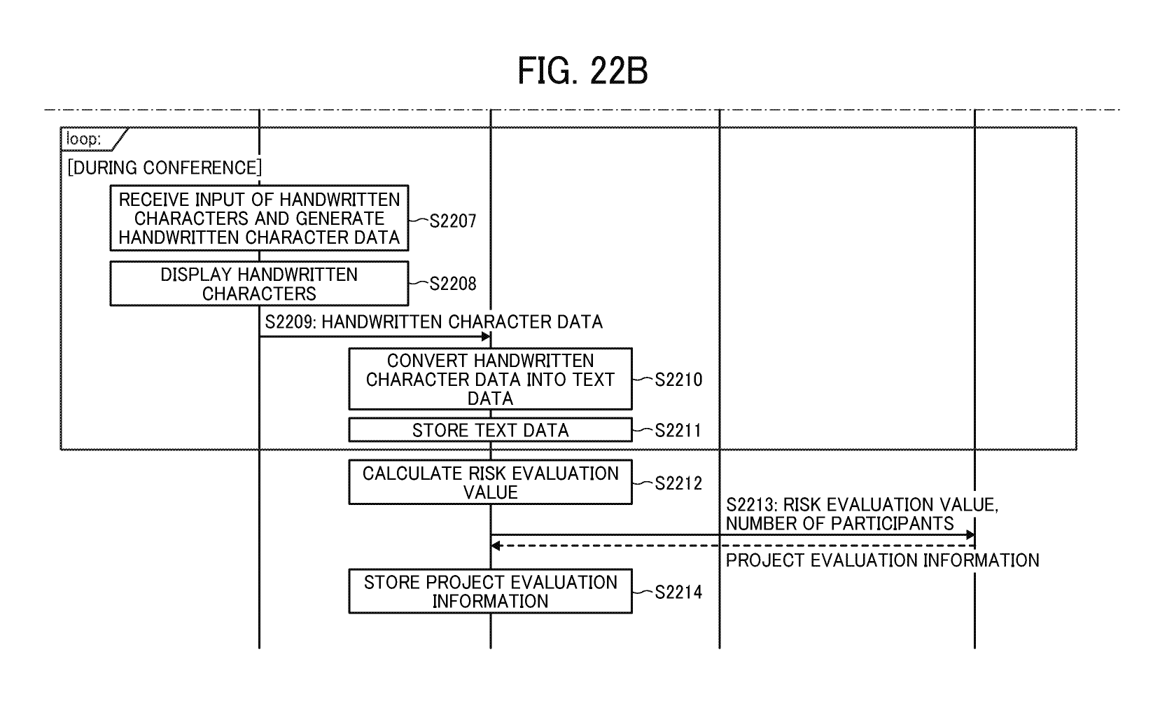

First, a functional configuration of the conference assistance system 1 according to the fifth embodiment will be described with reference to FIG. 20. FIG. 20 is a schematic diagram illustrating an example of the functional configuration of the conference assistance system 1 according to the fifth embodiment. Note that a description of functional units that are substantially the same as those of the fourth embodiment is omitted.

As illustrated in FIG. 20, the electronic whiteboard 10 according to the fifth embodiment includes a handwritten character data generation processor 106. The handwritten character data generation processor 106 is implemented by a process which one or more programs installed on the electronic whiteboard 10 cause the CPU 17 to execute.

In response to the input receiver 101 receiving a handwritten character input operation (an operation of inputting content of a conference performed by each participant of the conference by handwriting), the handwritten character data generation processor 106 generates data (handwritten character data) representing handwritten characters for which the input operation is received. The handwritten character data generation processor 106 also transmits the generated handwritten character data to the project management apparatus 20 via the communicator 103.

As illustrated in FIG. 20, the project management apparatus 20 according to the fifth embodiment includes a character converter 217, a risk evaluation value calculation processor 203D, and a text data manager 215A. The character converter 217 is implemented by a process which one or more programs installed on the project management apparatus 20 cause the CPU 27 to execute.

The project management apparatus 20 according to the fifth embodiment also includes a risk evaluation value table memory 206C.

The character converter 217 converts the handwritten character data received via the communicator 201 into text data. Note that the character converter 217 may convert the handwritten character data into text data by using an optical character recognition (OCR) technique, for example.

The risk evaluation value calculation processor 203D includes a number-of-characters calculator (counter) 216 and a risk evaluation value calculator 213C. The number-of-characters calculator 216 counts the number of characters contained in the text data. With reference to a risk evaluation value table 1000C stored in the risk evaluation value table memory 206C, the risk evaluation value calculator 213C calculates a risk evaluation value from the number of characters calculated by the number-of-characters calculator 216. As described below, the risk evaluation value table 1000C stored in the risk evaluation value table memory 206C is a table in which the number of characters counted by the number-of-characters calculator 216 and the risk evaluation value are stored in association with each other.

The text data manager 215A manages text data stored in the text data memory 210. Specifically, the text data manager 215 causes text data obtained by the character converter 217 through conversion to be stored in the text data memory 210. The text data manager 215 also acquires text data stored in the text data memory 210.

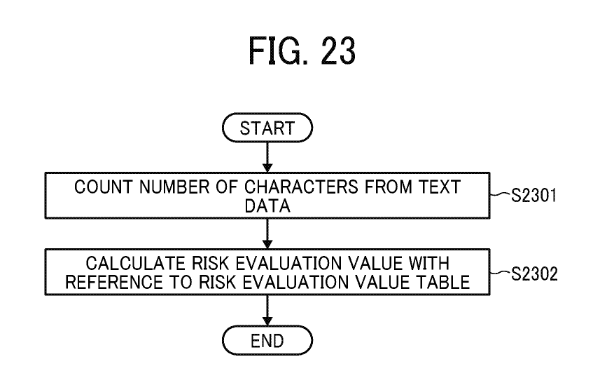

The risk evaluation value table memory 206C stores the risk evaluation value table 1000C. The risk evaluation value table 1000C stored in the risk evaluation value table memory 206C will be described with reference to FIG. 21. FIG. 21 is an illustration of an example of the risk evaluation value table 1000C according to the fifth embodiment.

As illustrated in FIG. 21, in the risk evaluation value table 1000C, the number of characters contained in the text data is associated with the risk evaluation value. For example, the number of characters that is “more than or equal to 50 characters” is associated with a risk evaluation value of “0 points”. Likewise, for example, the number of characters that is “more than or equal to 20 characters and less than 50 characters” is associated with a risk evaluation value of “1 point”. In addition, for example, the number of characters that is “less than 20 characters” is associated with a risk evaluation value of “2 points”.

As described above, in the risk evaluation value table 1000C, the risk evaluation value is associated with the number of characters contained in text data into which handwritten characters are converted, in accordance with the number of characters.

<Details of Process>

Details of a process performed by the conference assistance system 1 according to the fifth embodiment will be described.

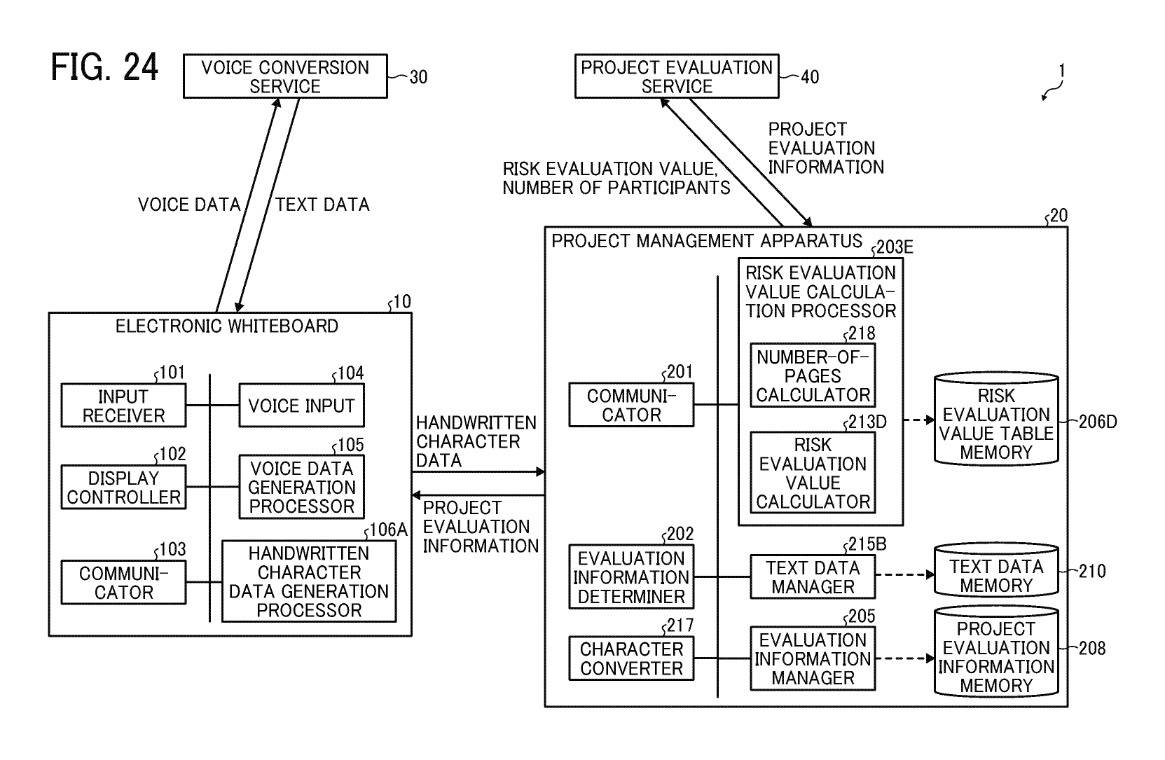

The overview of the process performed by the conference assistance system 1 according to the fifth embodiment will be described below with reference to FIG. 22. FIG. 22 is a sequence diagram illustrating an example of the overview of the process performed by the conference assistance system 1 according to the fifth embodiment. Since processing of steps S2201 to S2206 is substantially the same as the processing of steps S501 to S506 illustrated in FIG. 5, a description thereof is omitted.

As in the first embodiment, after the OK button G120 is pressed or after the information indicating that the project evaluation information is not stored is returned, the conference assistance system 1 according to the fifth embodiment performs processing of steps S2207 to S2211 (described later) while the conference is continued using the electronic whiteboard 10.

Specifically, the input receiver 101 of the electronic whiteboard 10 receives a handwritten character input operation performed by each participant of the conference. The handwritten character data generation processor 106 of the electronic whiteboard 10 then generates data (handwritten character data) representing the handwritten characters for which the input operation is received (step S2207).

Then, the display controller 102 of the electronic whiteboard 10 displays the handwritten characters for which the input operation is received by the input receiver 101 (step S2208). Consequently, handwritten characters input by each participant of the conference by using an electronic pen or the like are displayed on the display device 12.

Then, the handwritten character data generation processor 106 of the electronic whiteboard 10 transmits the generated handwritten character data to the project management apparatus 20 via the communicator 103 (step S2209).

The character converter 217 of the project management apparatus 20 converts the handwritten character data received via the communicator 201 into text data (step S2210).

Then, the text data manager 215A of the project management apparatus 20 causes the text data obtained by the character converter 217 through the conversion to be stored in the text data memory 210 (step S2211). At that time, the text data manager 215A causes the text data to be stored in the text data memory 210 in association with the project identification information received in step S2203.

In this way, text data representing content handwritten by each participant of the conference held using the electronic whiteboard 10 is stored in the text data memory 210.

After the conference using the electronic whiteboard 10 is finished, the conference assistance system 1 according to the fifth embodiment performs processing of steps S2212 to S2214. Since the processing of steps S2213 and S2214 is substantially the same as the processing of steps S513 and S514 illustrated in FIG. 5, a description thereof is omitted. As in FIG. 5, in response to receiving, for example, a use end operation performed by the user, the input receiver 101 of the electronic whiteboard 10 may transmit information indicating the end of the conference to the project management apparatus 20 via the communicator 103. In addition, the project management apparatus 20 may determine that the conference is finished if the project management apparatus 20 receives no handwritten character data from the electronic whiteboard 10 over a predetermined period, for example.

The risk evaluation value calculation processor 203D of the project management apparatus 20 calculates a risk evaluation value (step S2212).

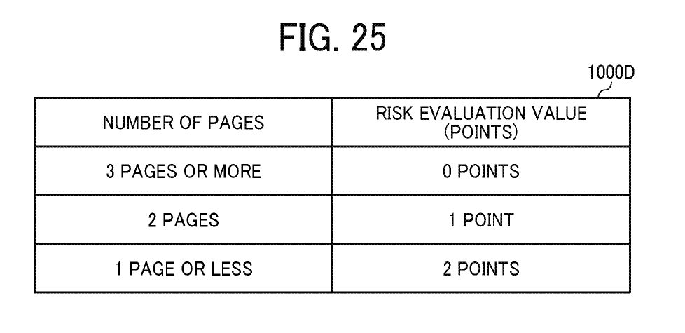

A process of calculating the risk evaluation value (risk evaluation value calculation process) performed in step S2212 will be described with reference to FIG. 23. FIG. 23 is a flowchart illustrating an example of the risk evaluation value calculation process according to the fifth embodiment.

First, the number-of-characters calculator 216 acquires, via the text data manager 215A, text data stored in the text data memory 210 in association with the project identification information received in step S2203 illustrated in FIG. 22. Then, the number-of-characters calculator 216 counts the number of characters contained in the acquired text data (step S2301).

Then, with reference to the risk evaluation value table 1000C stored in the risk evaluation value table memory 206C, the risk evaluation value calculator 213C calculates a risk evaluation value from the number of characters calculated by the number-of-characters calculator 216 (step S2302). This calculation is performed based on assumption that, if the number of handwritten characters input to the electronic whiteboard 10 is small, the project tends to be stagnant and result in a failure.

As described above, the conference assistance system 1 according to the fifth embodiment successfully evaluates a project based on the number of handwritten characters input to the electronic whiteboard 10.

Thus, as described above, the conference assistance system 1 according to the fifth embodiment can evaluate a project without requiring participants of the conference held using the electronic whiteboard 10 to perform various input operation for evaluating the project or without causing the participants to be conscious about the various inputs for evaluating the project, for example. That is, the conference assistance system 1 according to the fifth embodiment can evaluate a project if participants of the conference merely input content of the conference as handwritten characters.

A sixth embodiment will be described next. In the sixth embodiment, a project is evaluated on the basis of the number of pages for which handwritten characters are input by using an electronic pen or the like to the electronic whiteboard 10 capable of assigning pages and receiving input handwritten characters.

<Functional Configuration>

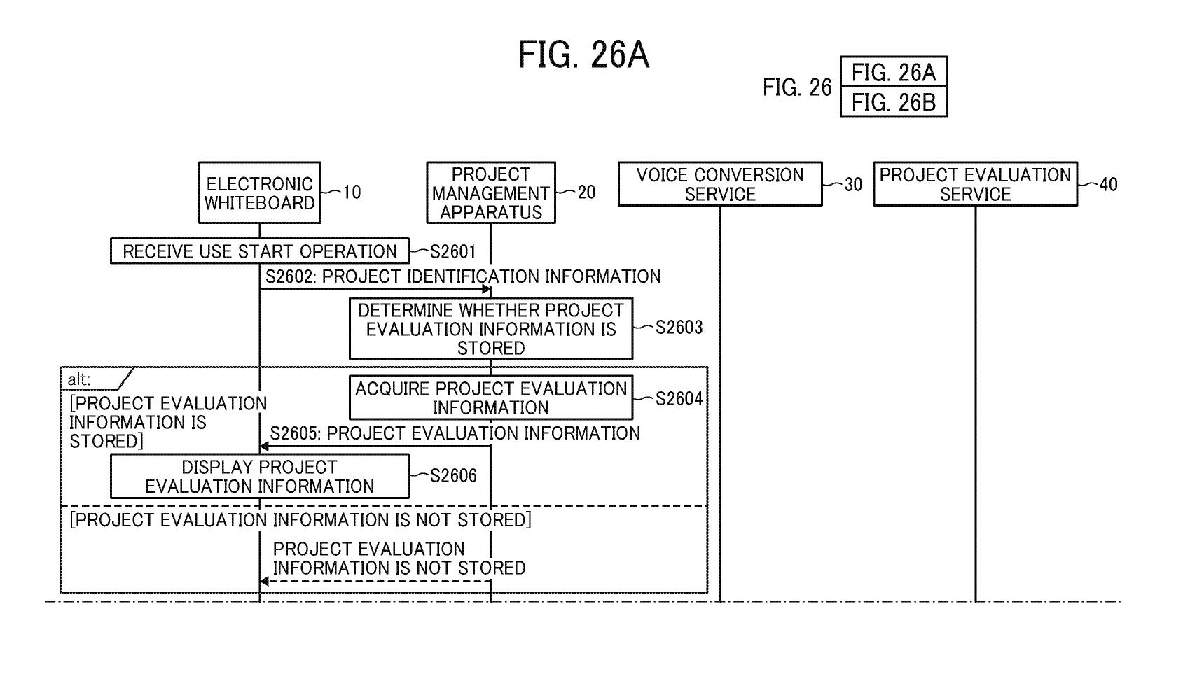

First, a functional configuration of the conference assistance system 1 according to the sixth embodiment will be described with reference to FIG. 24. FIG. 24 is a schematic diagram illustrating an example of the functional configuration of the conference assistance system 1 according to the sixth embodiment. Note that a description of functional units that are substantially the same as those of the fifth embodiment is omitted.

As illustrated in FIG. 24, the electronic whiteboard 10 according to the sixth embodiment includes a handwritten character data generation processor 106A. In response to the input receiver 101 receiving a handwritten character input operation, the handwritten character data generation processor 106A generates data (handwritten character data) representing handwritten characters for which the input operation is received. The handwritten character data generation processor 106A also transmits, to the project management apparatus 20 via the communicator 103, the generated handwritten character data and the page number(s) of page(s) for which the handwritten characters are input.

As illustrated in FIG. 24, the project management apparatus 20 according to the sixth embodiment includes a risk evaluation value calculation processor 203E and a text data manager 215B.

The project management apparatus 20 according to the sixth embodiment also includes a risk evaluation value table memory 206D.

The risk evaluation value calculation processor 203E includes a number-of-pages calculator 218 and a risk evaluation value calculator 213D. The number-of-pages calculator (counter) 218 counts the number of pages indicating the total number of pages for which the handwritten characters are input. With reference to a risk evaluation value table 1000D stored in the risk evaluation value table memory 206D, the risk evaluation value calculator 213D calculates a risk evaluation value from the number of pages calculated by the number-of-pages calculator 218. As described later, the risk evaluation value table 1000D stored in the risk evaluation value table memory 206D is a table in which the number of pages counted by the number-of-pages calculator 218 and the risk evaluation value are associated with each other.

The text data manager 215B manages text data stored in the text data memory 210. Specifically, the text data manager 215 causes text data obtained by the character converter 217 through conversion to be stored in the text data memory 210 in association with the page number(s) received via the communicator 201. The text data manager 215 also acquires text data stored in the text data memory 210 and the page number(s) associated with the text data.

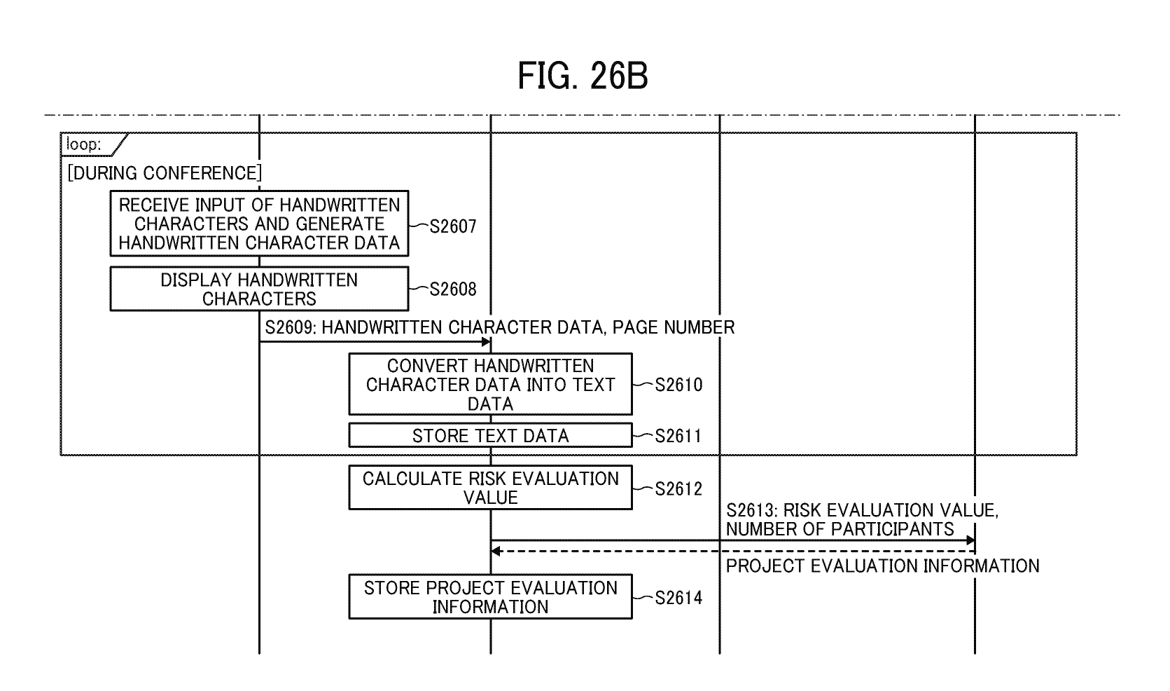

The risk evaluation value table memory 206D stores the risk evaluation value table 1000D. The risk evaluation value table 1000D stored in the risk evaluation value table memory 206D will be described with reference to FIG. 25. FIG. 25 is an illustration of an example of the risk evaluation value table 1000D according to the sixth embodiment.

As illustrated in FIG. 25, in the risk evaluation value table I 000D, the number of pages indicating the total number of pages for which handwritten characters are input is associated with the risk evaluation value. For example, the number of pages that is “3 pages or more” is associated with a risk evaluation value of “0 points”. Likewise, for example, the number of pages that is “2 pages” is associated with a risk evaluation value of “1 point”. In addition, for example, the number of pages that is “1 page or less” is associated with a risk evaluation value of “2 points”.

As described above, in the risk evaluation value table 1000D, the risk evaluation value is associated with the total number of pages (number of pages) for which handwritten characters are input in accordance with the total number of pages.

<Details of Process>

Details of a process performed by the conference assistance system 1 according to the sixth embodiment will be described.

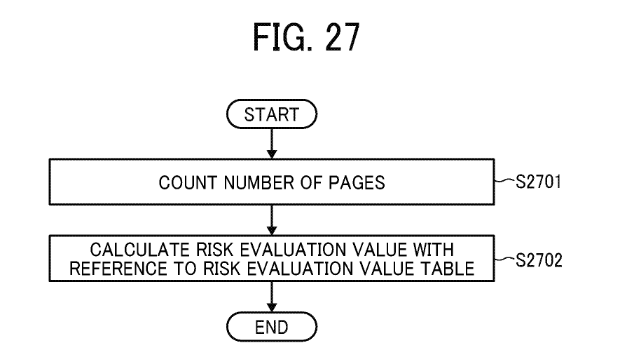

The overview of the process performed by the conference assistance system 1 according to the sixth embodiment will be described below with reference to FIG. 26. FIG. 26 is a sequence diagram illustrating an example operation of evaluating a project, performed by the conference assistance system 1 according to the sixth embodiment. Since processing of steps S2601 to S2608 is substantially the same as the processing of steps S2201 to S2208 illustrated in FIG. 22, a description thereof is omitted.

After step S2608, the handwritten character data generation processor 106A of the electronic whiteboard 10 transmits, to the project management apparatus 20 via the communicator 103, the generated handwritten character data and the page number(s) of page(s) for which the handwritten characters are input (step S2609).

The character converter 217 of the project management apparatus 20 converts the handwritten character data received via the communicator 201 into text data (step S2610).

Then, the text data manager 215B of the project management apparatus 20 causes the text data obtained by the character converter 217 through the conversion to be stored in the text data memory 210 in association with the page number(s) received via the communicator 201 (step S2611). At that time, the text data manager 215B causes the text data to be stored in the text data memory 210 also in association with the project identification information received in step S2803.

In this way, text data representing content handwritten by each participant of the conference held using the electronic whiteboard 10 is stored in the text data memory 210 in association with the page number(s).

After the conference using the electronic whiteboard 10 is finished, the conference assistance system 1 according to the sixth embodiment performs processing of steps S2612 to S2614. Since the processing of steps S2613 and S2614 is substantially the same as the processing of steps S513 and S514 illustrated in FIG. 5, a description thereof is omitted. As in FIG. 5, in response to receiving, for example, a use end operation performed by the user, the input receiver 101 of the electronic whiteboard 10 may transmit information indicating the end of the conference to the project management apparatus 20 via the communicator 103. In addition, the project management apparatus 20 may determine that the conference is finished if the project management apparatus 20 receives no handwritten character data from the electronic whiteboard 10 over a predetermined period, for example.

The risk evaluation value calculation processor 203E of the project management apparatus 20 calculates a risk evaluation value (step S2612).

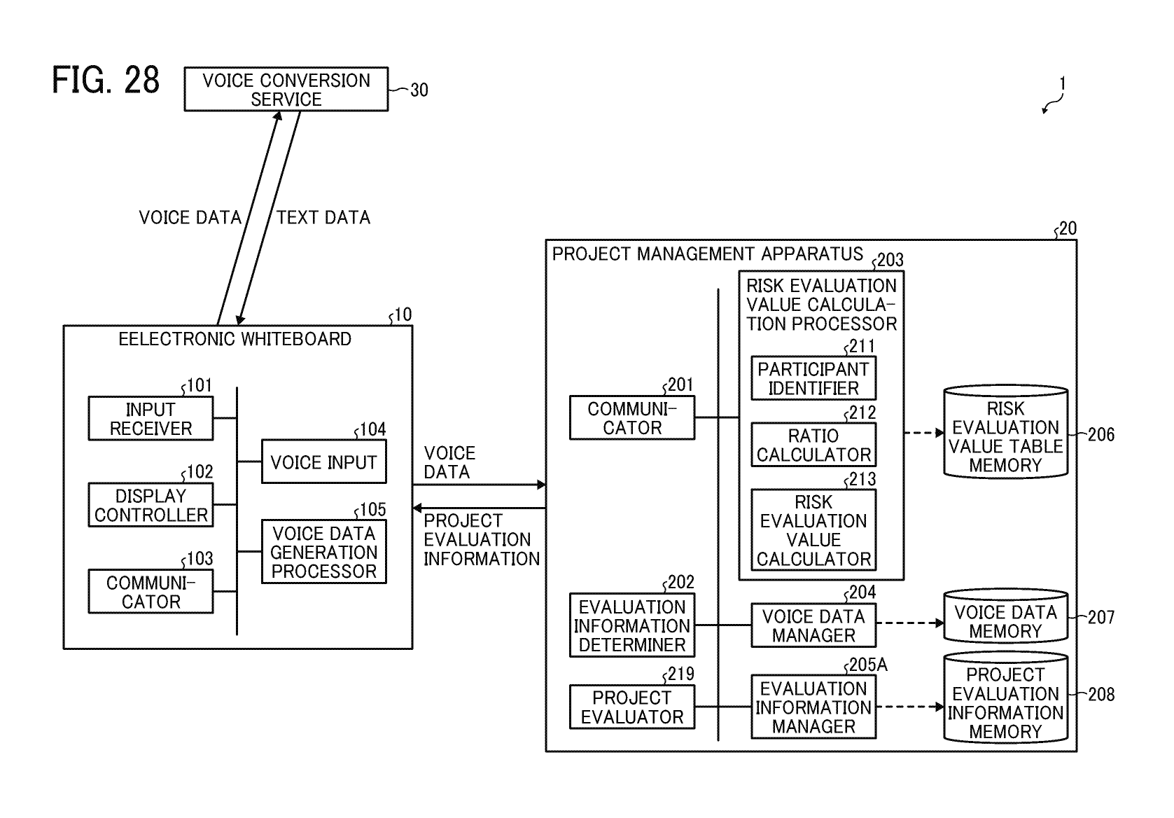

A process of calculating the risk evaluation value (risk evaluation value calculation process) performed in step S2612 will be described with reference to FIG. 27. FIG. 27 is a flowchart illustrating an example of the risk evaluation value calculation process according to the sixth embodiment.

First, the number-of-pages calculator 218 acquires, via the text data manager 215B, the page numbers stored in the text data memory 210 in association with the project identification information received in step S2603 illustrated in FIG. 26. Then, the number-of-pages calculator 218 obtains, as the number of pages, the largest page number among the acquired page numbers (step S2701).

Then, with reference to the risk evaluation value table 1000D stored in the risk evaluation value table memory 206D, the risk evaluation value calculator 213D calculates a risk evaluation value from the number of pages calculated by the number-of-pages calculator 218 (step S2702). This calculation is performed based on assumption that, if the number of pages for which handwritten characters are input to the electronic whiteboard 10 is small, the project tends to be stagnant and result in a failure.

As described above, the conference assistance system 1 according to the sixth embodiment can evaluate a project based on the number of pages for which handwritten characters are input to the electronic whiteboard 10.

A seventh embodiment will be described next. In the seventh embodiment, project evaluation information provided by the project evaluation service 40 in the above embodiments is created by the project management apparatus 20.

<Functional Configuration>

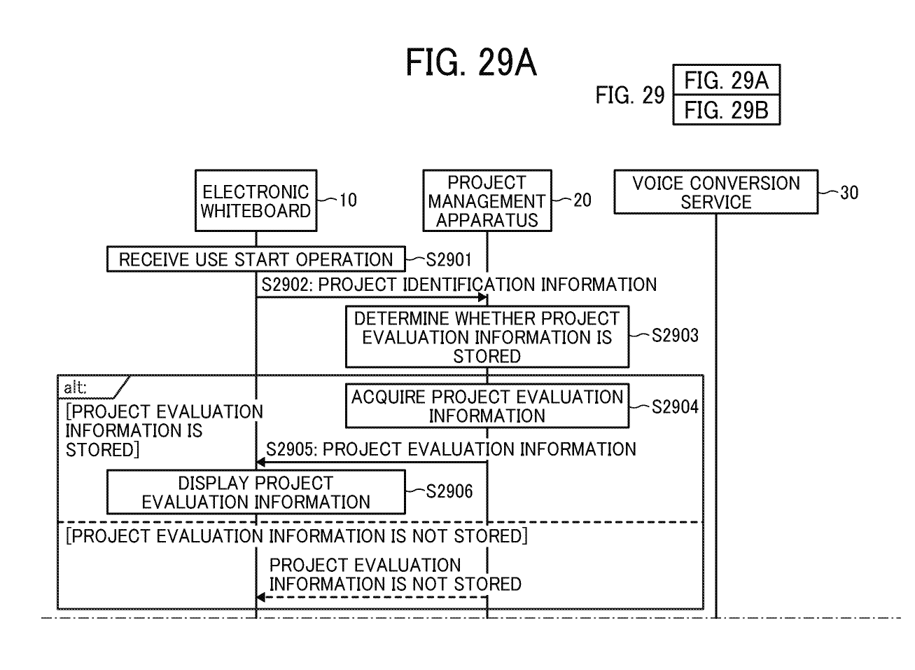

First, a functional configuration of the conference assistance system 1 according to the seventh embodiment will be described with reference to FIG. 28. FIG. 28 is a schematic diagram illustrating an example of the functional configuration of the conference assistance system 1 according to the seventh embodiment. Note that a description of functional units that are substantially the same as those of the first embodiment is omitted.

As illustrated in FIG. 28, the project management apparatus 20 according to the seventh embodiment includes an evaluation information manager 205A and a project evaluator 219. The project evaluator 219 is implemented by a process which one or more programs installed on the project management apparatus 20 cause the CPU 17 to execute.

The project evaluator 219 evaluates, by using a technology of AI or IA, for example, whether the project is stagnant based on the risk evaluation value calculated by the risk evaluation value calculation processor 203 and creates project evaluation information.

The evaluation information manager 205A manages project evaluation information stored in the project evaluation information memory 208. Specifically, the evaluation information manager 205A causes the project evaluation information created by the project evaluator 219 to be stored in the project evaluation information memory 208. The evaluation information manager 205A also acquires project evaluation information stored in the project evaluation information memory 208.

<Details of Process>

Details of a process performed by the conference assistance system 1 according to the seventh embodiment will be described next.

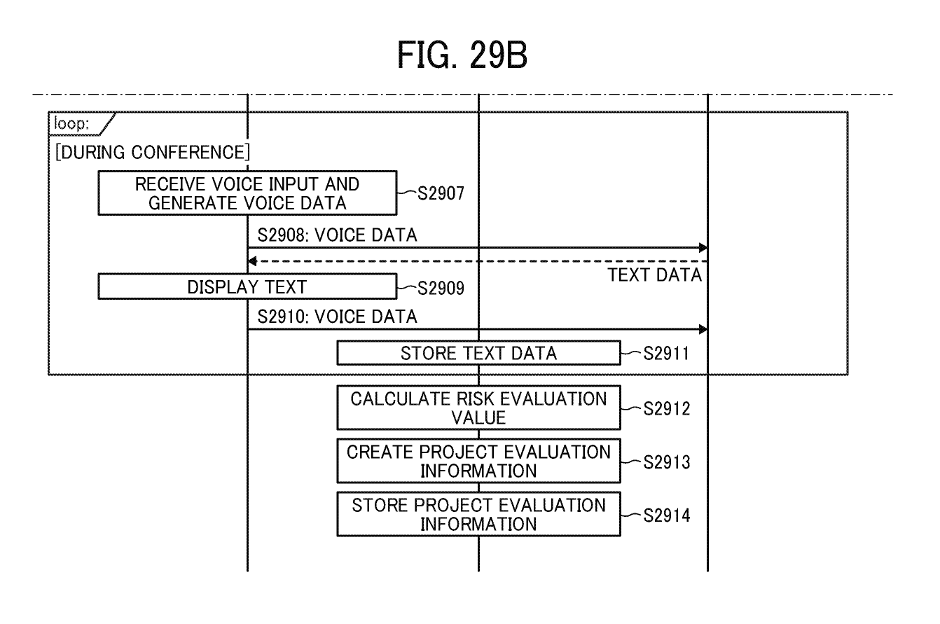

The overview of the process performed by the conference assistance system 1 according to the seventh embodiment will be described below with reference to FIG. 29. FIG. 29 is a sequence diagram illustrating an example operation of evaluating a project, performed by the conference assistance system 1 according to the seventh embodiment. Since processing of steps S2901 to S2912 is substantially the same as the processing of steps S501 to S512 illustrated in FIG. 5, a description thereof is omitted.

After step S2912, the project evaluator 219 of the project management apparatus 20 creates project evaluation information on the basis of the risk evaluation value calculated by the risk evaluation value calculation processor 203 (step S2913). As described with reference to FIG. 9, the project evaluator 219 evaluates whether the project is stagnant based on stored information regarding the past failing projects and creates the project evaluation information, for example.

Then, the evaluation information manager 205A of the project management apparatus 20 causes the project evaluation information created by the project evaluator 219 to be stored in the project evaluation information memory 208 (step S2914). At that time, the evaluation information manager 205A causes the project evaluation information to be stored in the project evaluation information memory 208 in association with the project identification information received in step S2903.

As described above, the project evaluation information is created by the project management apparatus 20 in the conference assistance system 1 according to the seventh embodiment. With this configuration, the conference assistance system 1 according to the seventh embodiment can evaluate a project without transmitting information such as the risk evaluation value to an external service, for example.

In the seventh embodiment, the case where the project management apparatus 20 includes the project evaluator 219 is described. However, the configuration is not limited to this one. For example, the electronic whiteboard 10 may include the project evaluator 219. In this case, the electronic whiteboard 10 receives the risk evaluation value from the project management apparatus 20. Alternatively, an apparatus or system that is different from the electronic whiteboard 10 and from the project management apparatus 20 and that includes the project evaluator 219 may be included in the conference assistance system 1.

The case where voices or handwritten characters are input to the electronic whiteboard 10 is described as an example in the first to seventh embodiments above. However, the configuration is not limited to this one, and each of the first to seventh embodiments is applicable to a device other than the electronic whiteboard 10.

For example, each of the first to seventh embodiments is also applicable to a projector that projects an image based on image data, and a videoconference terminal for transmitting and receiving image data and voice data to and from a plurality of terminals. That is, each of the first to seventh embodiments is applicable to various kinds of devices that are capable of receiving input of at least one of voices or handwritten characters and that are used for a conference.

In case the projector is used to input handwritten characters, the projector may be input with drawings made by a user on a screen projected by the projector, using an electronic pen or a user's finger, for example. Further, the user is able to write on an image that is projected with the projector, such as an image of presentation material.

Similarly, in case the videoconference terminal is used to input handwritten characters, the videoconference terminal may be input with drawings made by a user on a screen, which may be displayed or projected. For example, any writing made by the user, for example, on the electronic whiteboard or any material (such as paper or wall) may be captured using a camera of the videoconference terminal. Further, the videoconference terminal is able to catch, using a microphone, voices of participants.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

For example, the conference assistance system includes a plurality of computing devices, e.g., a server cluster, that are configured to communicate with each other over any type of communications link, including a network, a shared memory, etc. to collectively perform the processes disclosed herein.

In any one of the above-described embodiments, the project evaluation service 40 for assisting a user to evaluate the project is used as a system that utilizes conference information that is obtained during the conference using an electronic apparatus, such as the electronic whiteboard 10, projector, videoconference terminal, etc. Alternatively, any service capable of assisting a user by providing conference-related information, may be used other than the project evaluation service 40. Examples of such service include, but not limited to, organization management service, operation planning service, reporting service, etc.

Further, contents of a conference, such as discussion or agenda, are not limited to the one described above. Examples of the contents of conference include, but not limited to, reporting, scheduling, brainstorming, problem or issue identifying, coaching one or more members related to a project, or any other type of conferences or meetings that are usually held to achieve a goal to be shared by multiple users, such as a goal to be achieved by the project.

Further, a type of the conference being held is not limited to the conference being held on one site, such that any other type of conference including a conference to be performed online or any other tools such as a chat may be applicable.

Furthermore, while the above-described embodiments use information reflecting stagnancy or progress of a project, or a discussion related to the project, as an evaluation value to be used for evaluating a success of the project. Examples of such information reflecting stagnancy or progress of the project are not limited to this disclosure. For example, a time period during when team members other than a team leader of the project may only be counted as a time to be considered if the discussion is being stagnant.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A conference assistance system comprising:
a network interface configured to communicate with a project evaluation server; and circuitry configured to
receive voices or writings input by a plurality of participants participating in a conference relating to a project,
calculate, based on the received voices or writings, an evaluation value used for evaluating the project,
transmit the calculated evaluation value to the project evaluation server, and
control a display to display a project evaluation information representing an evaluation result of the project, the project evaluation information being received from the project evaluation server in response to transmission of the evaluation value.

2. The conference assistance system according to claim 1,
wherein the circuitry
counts, for each one of the participants, a total statement time during when the participant made statements in the conference based on the received voices of the participant, and
calculates a ratio of a longest total statement time of the total statement times of the respective participants, to a conference duration time, and
calculates the evaluation value in accordance with the calculated ratio.

3. The conference assistance system according to claim 1,
wherein the circuitry
calculates a ratio of a sum of periods for which none of the participants make any statement during the conference, to a conference duration time, and
calculates the evaluation value in accordance with the calculated ratio.

4. The conference assistance system according to claim 1,
wherein the circuitry
counts a number of times a predetermined term or a similar term synonymous with the predetermined term appears in the received voices in the conference, and
calculates the evaluation value in accordance with the counted number of times the predetermined term or similar term appears.

5. The conference assistance system according to claim 4,
wherein the circuitry converts the received voices into text data, and
the circuitry searches the text data for the predetermined term or similar term.

6. The conference assistance system according to claim 1,
wherein the received writings include one or more characters that are input via an electronic whiteboard, and
wherein the circuitry converts the input characters into text data, counts a number of the input characters in the text data, and calculates the evaluation value in accordance with the counted number of the input characters.

7. The conference assistance system according to claim 1,
wherein the received writings are input via an electronic whiteboard, and
wherein the circuitry assigns a page number to each page of a plurality of screens that have been written by at least one of the participants, and
calculates the evaluation value in accordance with a largest page number of the one or more pages that are assigned.

8. The conference assistance system according to claim 1,
wherein the evaluation value is used for evaluating whether the project is stagnant, and the project evaluation information indicates whether the project is stagnant.

9. The conference assistance system according to claim 1,
wherein the circuitry controls a display to display the project evaluation information received from the project evaluation server when a next conference related to the project starts.

10. The conference assistance system according to claim 1,
wherein the circuitry transmits the project evaluation information to an electronic whiteboard for display.

11. The conference assistance system according to claim 4,
wherein the predetermined term has an indication of stagnancy or progress of the project or the conference relating to the project.

12. A conference assistance system comprising circuitry to
receive voices or writings input by a plurality of participants participating in a conference relating to a project,
calculate, based on the received voices or writings, an evaluation value used for evaluating the project,
evaluate, based on the calculated evaluation value, the project to create project evaluation information representing a result of the evaluation, and
control a display to display the project evaluation information.

13. The conference assistance system according to claim 12,
wherein the circuitry obtains, from the received voices or writings, one or more types of information reflecting stagnancy of a discussion during the conference or the project, and
calculates the evaluation value based on the obtained types of information.

14. The conference assistance system according to claim 13, wherein the one or more types of information reflecting stagnancy include at least one of:
a ratio of a longest total statement time during when any participant has made statements in the conference, to a conference duration time;
a ratio of a sum of periods for which none of the participants has made any statement during the conference, to the conference duration time; and
a number of times a predetermined term or a similar term synonymous with the predetermined term appears in the received voices or writings.

15. The conference assistance system according to claim 14,
wherein the circuitry further converts the voices or writings into text data, and searches the text data for the predetermined term or the similar term.

16. The conference assistance system according to claim 12,
wherein the circuitry obtains, from the received voices or writings, one or more types of information reflecting progress of a discussion during the conference or the project, and
calculates the evaluation value based on the obtained types of information.

17. The conference assistance system according to claim 16, wherein the one or more types of information reflecting progress include at least one of:
a number of input characters that have been input, obtained from the received writings; and
a largest page number of one or more pages that have been input with characters, obtained from the received writings.

18. A method for assisting a user in project evaluation, comprising:
receiving voices or writings input by a plurality of participants participating in a conference relating to a project;
calculating, based on the received voices or writings, an evaluation value used for evaluating the project;
transmitting the calculated evaluation value to the project evaluation server; and
controlling a display to display a project evaluation information representing an evaluation result of the project, the project evaluation information being received from the project evaluation server in response to transmission of the evaluation value.

19. The method according to claim 18, further comprising:
obtaining, from the received voices or writings, one or more types of information reflecting stagnancy of a discussion during the conference or the project,
wherein the calculating includes calculating the evaluation value based on the obtained types of information,
the one or more types of information reflecting stagnancy including at least one of:
a ratio of a longest total statement time during when any participant has made statements in the conference, to a conference duration time;
a ratio of a sum of periods for which none of the participants has made any statement during the conference, to the conference duration time; and
a number of times a predetermined term or a similar term synonymous with the predetermined term appears in the received voices or writings.

20. The method according to claim 18, further comprising:
obtaining, from the received voices or writings, one or more types of information reflecting progress of a discussion during the conference or the project,
wherein the calculating includes calculating the evaluation value based on the obtained types of information,
the one or more types of information reflecting progress including at least one of:
a number of input characters that have been input, obtained from the received writings; and
a largest page number of one or more pages that have been input with characters, obtained from the received writings.
